(19) United States
(12) Patent Application Publication
(10) Pub. No.: US 2014/0063609 A1
(43) Pub. Date: Mar. 6, 2014

(54) OPTICAL BODY, DISPLAY DEVICE, INPUT DEVICE, AND ELECTRONIC DEVICE

(71) Applicant: Dexerials Corporation, Tokyo (JP)

(72) Inventors: Ryosuke IWATA, Utsunomiya-shi (JP); Mikihisa MIZUNO, Sendai-shi (JP); Akihiro SHIBATA, Sendai-shi (JP); Shinya SUZUKI, Natori-shi (JP)

(73) Assignee: Dexerials Corporation, Tokyo (JP)

(21) Appl. No.: 14/013,651

(22) Filed: Aug. 29, 2013

(30) Foreign Application Priority Data
Aug. 31, 2012 (JP) 2012-192271

(51) Int. Cl. G02B 1/11

(52) U.S. Cl. CPC G02B 1/118
USPC 359/601

(57) ABSTRACT

An optical body has an anti-reflection function and can be produced without repeating sequential coating to stack a low refractive index layer and a high refractive index layer. The optical body having an anti-reflection function includes a minute concave-convex surface having fluctuations. The minute concave-convex surface has an arithmetic average roughness Ra of smaller than or equal to 25 nm.

### TECHNICAL FIELD

The present technique relates to an optical body, a display device, an input device, and an electronic device. More particularly, the present technique relates to an optical body having an anti-reflection function.

### BACKGROUND ART

A well-known technique for improving the display quality of a display device is to impart an anti-reflection (AR) function to a top surface thereof. A currently-available technique in order to impart such an anti-reflection function to a display device is such that a thin film of a low refractive index substance and that of a high refractive index substance are stacked on the top surface of the display device to obtain an anti-reflection effect against light in a visible region (see Patent Literature 1, for example).

In general, in order to impart an anti-reflection function to a display device, an anti-reflection function is imparted to a transparent support and the transparent support is adhered to the display device. In order to produce the transparent support having an anti-reflection function, it is necessary to perform two-layer coating of a low refractive index layer and a high refractive index layer on the support. When a higher level of anti-reflection function is desired, three layers or four or more layers need to be deposited. As described above, sequential coating needs to be repeated to stack the low refractive index layer and the high refractive index layer on the transparent support in order to impart an anti-reflection function to a display device.

### CITATION LIST

### Patent Literature

Patent Literature 1: JP 2006-23904 A

### SUMMARY OF INVENTION

### Technical Problem(s)

However, repeating such sequential coating impedes the price of a product from being reduced in terms of the process thereof. Also, a material of the low refractive index layer is typically expensive, thereby preventing a cost reduction.

Thus, it is an object of the present technique to provide an optical body, a display device, an input device, and an electronic device having an anti-reflection function and capable of being produced without repeating sequential coating to stack a low refractive index layer and a high refractive index layer.

### Solution to Problem(s)

In order to solve the above-described problem, the first technique is an optical body having an anti-reflection function and comprising a minute concave-convex surface having fluctuations, wherein

the minute concave-convex surface has an arithmetic average roughness Ra of 25 nm or less.

The second technique is an input device comprising an input surface having an anti-reflection function, the input surface including a minute concave-convex surface having fluctuations, wherein and the minute concave-convex surface has an arithmetic average roughness Ra of 25 nm or less.

The third technique is a display device comprising a display surface having an anti-reflection function, the display surface including a minute concave-convex surface having fluctuations, wherein the minute concave-convex surface has an arithmetic average roughness Ra of 25 nm or less.

The fourth technique is an electronic device comprising a surface having an anti-reflection function, the surface including a minute concave-convex surface having fluctuations, wherein the minute concave-convex surface has an arithmetic average roughness Ra of 25 nm or less.

According to the present technique, by providing the minute concave-convex surface having fluctuations, an anti-reflection function can be obtained. Therefore, there is no need to form an anti-reflection layer by repeating sequential coating so as to stack a low refractive index layer and a high refractive index layer as in the conventional anti-reflection technique. Moreover, since the arithmetic average roughness Ra of the minute concave-convex surface is smaller than or equal to 25 nm, it is possible to suppress an increase in haze.

### Advantageous Effects of Invention

As described above, the anti-reflection function can be obtained according to the present technique without repeating sequential coating to stack a low refractive index layer and a high refractive index layer.

### BRIEF DESCRIPTION OF DRAWINGS

FIG. 1A is a plan view illustrating an exemplary configuration of an optical element according to a first embodiment of the present technique;

FIG. 1B is a cross-sectional view taken along the line a-a shown in FIG. 1A;

FIG. 1C is a cross-sectional view illustrating a portion of FIG. 1B in an enlarged manner;

FIG. 2A is a plan view illustrating an exemplary configuration of a plate-shaped master;

FIG. 2B is a cross-sectional view taken along the line a-a shown in FIG. 2A;

FIG. 2C is a cross-sectional view showing a portion of FIG. 2B in an enlarged manner;

FIG. 3 is a schematic view illustrating an exemplary configuration of a laser processing device for producing the plate-shaped master;

FIGS. 4A, 4B, and 4C each are a process diagram illustrating an example of a method for producing the optical element according to the first embodiment of the present technique;

FIGS. 5A, 5B, and 5C each are a process diagram illustrating an example of a structure forming process by means of an energy-ray curable resin or a thermosetting resin;

FIGS. 6A, 6B, and 6C each are a process diagram illustrating an example of a structure forming process by means of a thermoplastic resin composition;

FIG. 7A is a cross-sectional view illustrating an exemplary configuration of an optical element according to a first modified example;

FIG. 7B is a cross-sectional view showing an exemplary configuration of an optical element according to a second modified example;

FIG. 7C is a cross-sectional view illustrating an exemplary configuration of an optical element according to a third modified example;

FIG. 8A is a cross-sectional view showing an exemplary configuration of an optical element according to a fourth modified example;

FIG. 8B is a cross-sectional view showing an exemplary configuration of an optical element according to a fifth modified example;

FIG. 9A is a cross-sectional view showing an exemplary configuration of an optical element according to a second embodiment of the present technique;

FIG. 9B is a cross-sectional view illustrating a portion of FIG. 9A in an enlarged manner;

FIG. 10A is a perspective view showing an exemplary configuration of a roller master;

FIG. 10B is a cross-sectional view taken along the line a-a shown in FIG. 10A;

FIG. 10C is a cross-sectional view illustrating a portion of FIG. 10B in an enlarged manner;

FIG. 11 is a schematic view illustrating an exemplary configuration of a laser processing device for producing the roller master;

FIGS. 12A, 12B, and 12C each are a process diagram illustrating an example of a method for producing an optical element according to a third embodiment of the present technique;

FIGS. 13A and 13B each are a process diagram illustrating an example of a structure forming process by means of an energy-ray curable resin or a thermosetting resin;

FIGS. 14A and 14B each are a process diagram illustrating an example of a structure forming process by means of a thermoplastic resin composition;

FIGS. 15A and 15B each are a cross-sectional view illustrating an exemplary configuration of an optical element according to a fourth embodiment of the present technique;

FIG. 16 is a cross-sectional view illustrating a portion of FIG. 15A in an enlarged manner;

FIG. 17 is a perspective view illustrating an exemplary configuration of a display device according to a fifth embodiment of the present technique;

FIG. 18A is a perspective view illustrating an exemplary configuration of an input device according to a sixth embodiment of the present technique;

FIG. 18B is an exploded perspective view illustrating a modified example of the input device according to the sixth embodiment of the present technique;

FIG. 19A is an external view showing a TV device as an example of an electronic device;

FIG. 19B is an external view showing a laptop personal computer as an example of the electronic device;

FIG. 20A is an external view showing a mobile phone as an example of the electronic device;

FIG. 20B is an external view showing a tablet computer as an example of the electronic device;

FIG. 21A is a plan view illustrating an exemplary configuration of a frame according to an eighth embodiment of the present technique;

FIG. 21B is a cross-sectional view illustrating an exemplary configuration of a cover member;

FIG. 22A is a plan view illustrating an exemplary configuration of a photo according to a ninth embodiment of the present technique;

FIG. 22B is a cross-sectional view taken along the line A-A shown in FIG. 22A;

FIG. 23A shows an AFM image of a surface of an anti-reflection film of Example 1;

FIG. 23B shows a cross-sectional profile taken along the line a-a shown in FIG. 23A;

FIG. 24A shows an AFM image of a surface of an anti-reflection film of Example 2;

FIG. 24B shows a cross-sectional profile taken along the line a-a shown in FIG. 24A;

FIG. 25A shows an AFM image of a surface of an anti-reflection film of Example 3;

FIG. 25B shows a cross-sectional profile taken along the line a-a shown in FIG. 25A;

FIG. 26A shows an AFM image of a surface of an anti-reflection film of Example 4;

FIG. 26B shows a cross-sectional profile taken along the line a-a shown in FIG. 26A;

FIG. 27A shows an AFM image of a surface of an anti-reflection film of Example 5;

FIG. 27B shows a cross-sectional profile taken along the line a-a shown in FIG. 27A;

FIG. 28A shows an AFM image of a surface of an anti-reflection film of Example 6;

FIG. 28B shows a cross-sectional profile taken along the line a-a shown in FIG. 28A;

FIG. 29A shows an AFM image of a surface of an anti-reflection film of Example 7;

FIG. 29B shows a cross-sectional profile taken along the line a-a shown in FIG. 29A; and

FIG. 30 shows reflectance spectra of the anti-reflection films of Examples 1 to 6 and Comparative Example 1.

### DESCRIPTION OF EMBODIMENTS

Embodiments of the present technique will be described in the following order.

1. The first embodiment (an example of an optical element having a minute concave-convex surface)
2. The second embodiment (an example of an optical element having a minute concave-convex surface)
3. The third embodiment (an example of a method for producing an optical element)
4. The fourth embodiment (an example of a transparent conductive element having a minute concave-convex surface)
5. The fifth embodiment (an example of a display device having a minute concave-convex surface)
6. The sixth embodiment (an example of an input device having a minute concave-convex surface)
7. The seventh embodiment (an example of an electronic device having a minute concave-convex surface)
8. The eighth embodiment (an example of a frame having a minute concave-convex surface)
9. The ninth embodiment (an example of a photo having a minute concave-convex surface)

### 1. First Embodiment

### [Configuration of Optical Element]

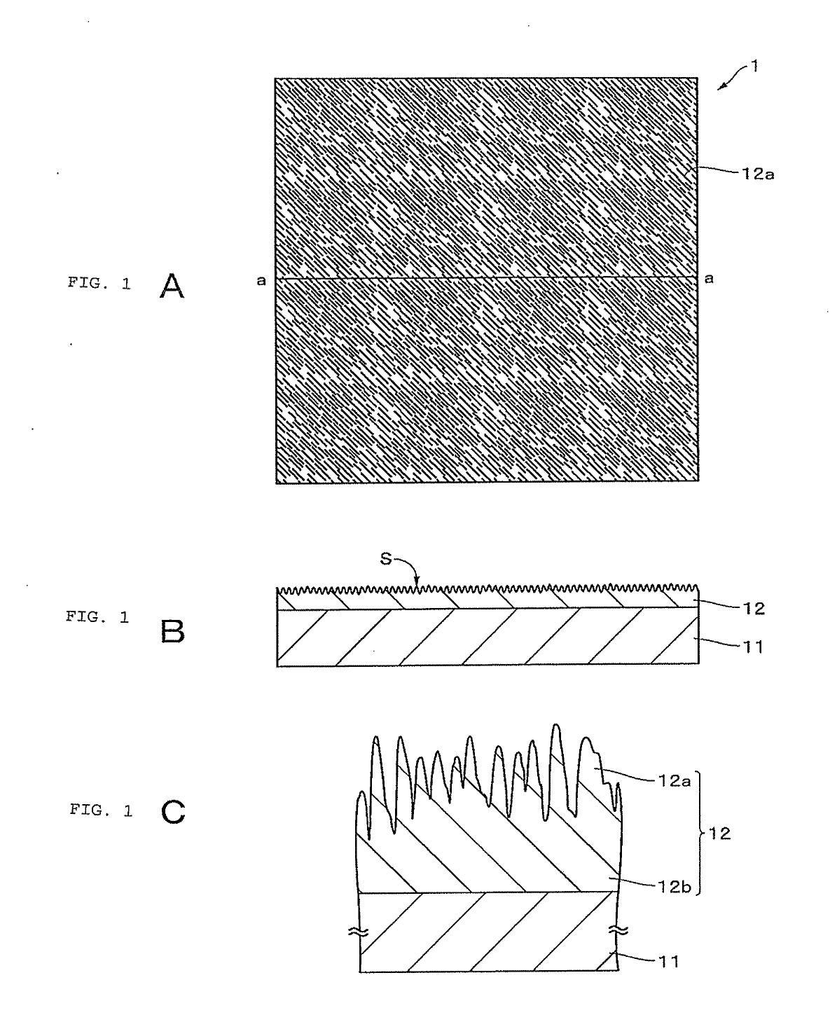

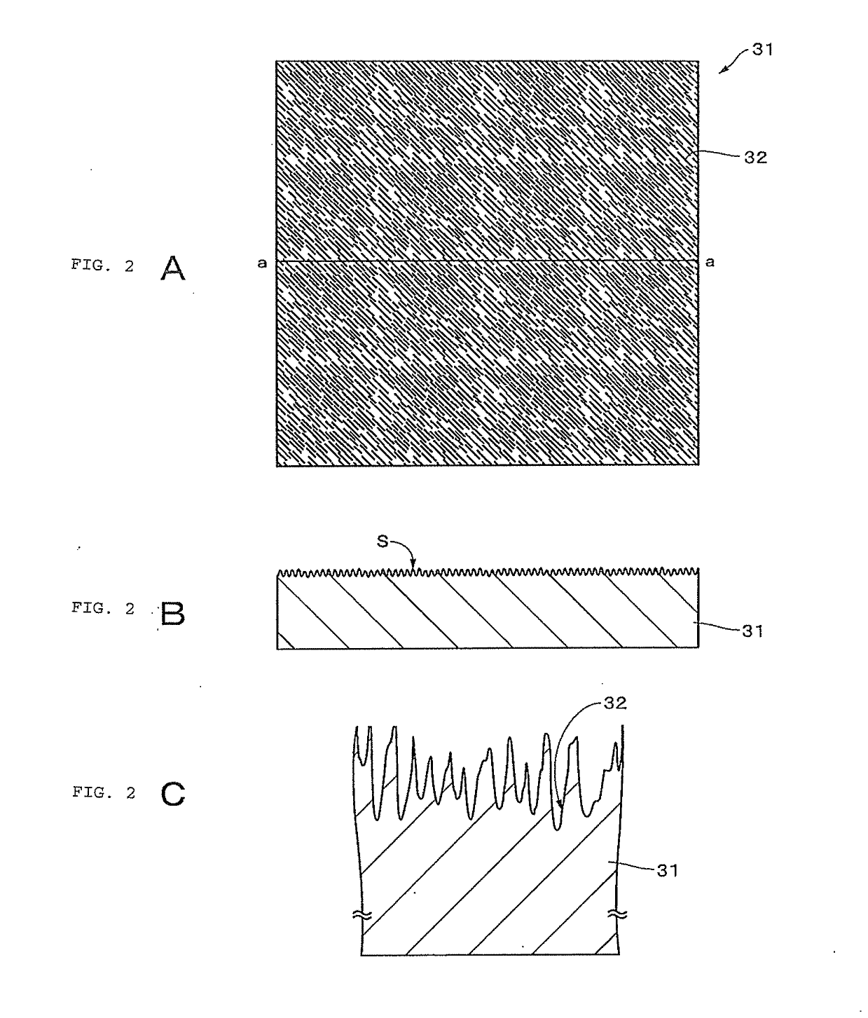

FIG. 1A is a plan view illustrating an optical element according to the first embodiment of the present technique. FIG. 1B is a cross-sectional view taken along the line a-a shown in FIG. 1A. FIG. 1C is a cross-sectional view illustrating a portion of FIG. 1B in an enlarged manner. The optical element (optical body) has a minute concave-convex surface S having an anti-reflection function. The minute concave-convex surface S has fluctuations in shape. Having fluctuations in shape makes it possible to prevent dispersion.

The optical element is one having an anti-reflection function, and includes: a base member 11 and a minute structure layer 12 provided on a surface of the base member 11. Although the optical element having the base member 11 and the minute structure layer 12 is herein illustrated as an optical body by way of example, the optical body is not limited to this example. The optical body can be configured solely by the minute structure layer 12.

The optical element according to the first embodiment is suitable to be applied to a surface for which an anti-reflection effect is desired. Examples of such an optical element having a surface for which the ant reflection effect is desired may include, without being limited to, a lens, a filter, a semi-transmissive mirror, a light control element, a prism, and a polarizing element. Alternatively, these optical elements each may be used as a base member and the minute structure layer 12 may be directly formed on a surface of the optical element serving as a base member.

Examples of an electronic device having a surface for which an anti-reflection effect is desired may include an electronic device having a display surface or an input surface, and an electronic device including an optical system. Examples of such an electronic device having a display surface or an input surface may include, without being limited to, a TV device, a personal computer, a mobile device (for example, a smartphone, a slate PC, etc.), a digital camera, a digital video camera, and a photo frame. Examples of the electronic device including an optical system may include, without being limited to, a digital camera and a digital video camera.

Examples of an optical device having a surface for which the anti-reflection effect is desired may include, without being limited to, a telescope, a microscope, an exposure device, a measurement device, an inspection device, and analytical equipment.

The application range of the optical element is not limited to the above-described devices. The optical element can be suitably applied to any article as long as it has a surface intended to be touched by a hand or a finger. Examples of such an article other than those mentioned above may include, without being limited to, paper, plastic, and glass products (specifically, for example, a photo, a photo frame, a plastic case, a glass window, a plastic window, a frame, a lens, electric appliances, etc.).

### (Base Member)

The base member 11 is a transparent inorganic or plastic base member, for example. Examples of a shape of the base member 11 may include a film shape, a sheet shape, a plate shape, and a block shape. Examples of the material of the inorganic base member may include quartz, sapphire, and glass. Examples of the material of the plastic base member may include known polymer materials. Specific examples of the known polymer materials may include triacetylcellulose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), polystyrene, diacetyl cellulose, polyvinyl chloride, an acrylic resin (PMMA), polycarbonate (PC), an epoxy resin, a urea resin, a urethane resin, a melamine resin, a phenol resin, an acrylonitrile-butadiene-styrene copolymer, a cycloolefin polymer (COP), a cycloolefin copolymer (COC), a PC/PMMA stacked product, and rubber-added PMMA.

The base member 11 may be processed as part of an exterior or a display of an electronic device or the like. Moreover, the surface shape of the base member 11 is not limited to a flat surface. A concave-convex surface, a polygonal surface, a curved surface, or a combination thereof may be used. Examples of such a curved surface may include a spherical surface, an ellipsoidal surface, a paraboloidal surface, and a free-curved surface. Also, a predetermined structure may be given to the surface of the base member 11 by means of UV transfer, thermal transfer, pressure transfer, melt extrusion, or the like, for example.

### (Minute Structure Layer)

The minute structure layer 12 has a minute concave-convex structure on a surface thereof. This concave-convex structure is a random nanostructure. More specifically, the concave-convex structure is formed by a plurality of nanosized structures 12a provided on the surface of the base member 11 in a random manner.

The concave-convex structure has an extended structure formed by convex portions and/or concave portions extending one-dimensionally or two-dimensionally, or a needle-shaped structure formed by needle-shaped convex portions provided two-dimensionally. These structures have fluctuations in their shapes. When the concave-convex structure has the above-described extended structure, the fluctuations thereof include, for example, fluctuations in the width direction of the convex portion of the concave-convex structure; fluctuations in the width direction of the concave portion of the concave-convex structure; fluctuations in the protruding direction of the convex portion of the concave-convex structure; and fluctuations in the depressed direction of the concave portion of the concave-convex structure. When the concave-convex structure has the needle-shaped structure, the fluctuations thereof include, for example, fluctuations in the size of the needle-shaped convex portion and fluctuations in the pitch between adjacent needle-shaped convex portions (distance between apexes of adjacent needle-shaped convex portions). The fluctuations in the size of the needle-shaped convex portion herein include fluctuations in the size of a bottom surface of the convex portion and fluctuations in the height of the convex portion.

The minute structure layer 12 may further include a basal layer 12b provided between the base member 11 and the plurality of structures 12a. The basal layer 12b is a layer integrally formed with the structures 12a on the side of the bottom surface of the structures 12a. The basal layer 12b is made of the material same as or similar to that of the structures 12a.

The minute structure layer 12 includes at least one composition selected from the group consisting of an energy-ray curable resin composition, a thermosetting resin composition, and a thermoplastic resin composition, for example. More specifically, the material of the minute structure layer 12 can be selected and used from, for example, a wide range of known natural polymeric resins and synthetic polymeric resins. Examples of the material used may include transparent thermoplastic resins (for example, polyvinyl chloride, a vinyl chloride-vinyl acetate copolymer, poly(methyl methacrylate), nitrocellulose, chlorinated polyethylene, chlorinated polypropylene, ethyl cellulose, and hydroxypropyl methylcellulose), and transparent curable resins to be cured by heat, light, electron beams, or radiation (for example, methacrylate, melamine acrylate, urethane acrylate, isocyanate, an epoxy resin, and a polyimide resin). Alternatively, an inorganic material may be employed as the material for the minute structure layer 12. Examples of such an inorganic material may include alkoxides of silica, titanium, zirconia, niobium, and the like, disilazane compounds of silica, and organic-inorganic composite materials.

The minute structure layer 12 may further include, as needed, an additive such as a polymerization initiator, a light stabilizer, an ultraviolet absorber, a catalyst, a colorant, an antistatic agent, a lubricant, a leveling agent, an antifoamer, a polymerization promoter, an antioxidant, a flame retardant, an infrared absorber, a surfactant, a surface modifier, a thixotropic agent, a viscosity modifier, a dispersant, a cure accelerator catalyst, a plasticizer, or an anti-sulfuration agent. An average film thickness of the minute structure layer 12 falls, for example, within a range between a monomolecular thickness and 1 mm, preferably within a range between the monomolecular thickness and 100 μm, and most preferably within a range between the monomolecular thickness and 10 μm.

### (Structure)

Each of the plurality of structures 12a has a convex shape with respect to the surface of the base member 11. The plurality of structures 12a are provided on the surface of the base member 11 in a random manner. A stripe shape, a mesh shape, or a needle shape, for example, can be employed as a shape of the structures 12a. FIG. 1A shows an example where the structures 12a form a stripe shape. The stripe shape and the mesh shape herein refer to shapes as viewed from a direction perpendicular to the minute concave-convex surface S. The needle shape refers to a shape as viewed from an in-plane direction of the minute concave-convex surface S.

The structures 12a together forming a stripe shape or a mesh shape have random fluctuations in the height direction of the structure 12a (i.e., the width direction of the base member 11) and in the width direction of the structure 12a (i.e., the in-plane direction of the base member 11). The structures 12a each having a needle shape are provided two-dimensionally in a random manner in the in-plane direction of the base member 11. The heights of the structures 12a each having a needle shape vary in a random manner. The stripe shape as used herein includes not only a configuration of the plurality of structures 12a continuously extending in one direction but also a configuration of the plurality of structures 12a intermittently extending in one direction. Furthermore, the stripe shape also includes a configuration in which the plurality of structures 12a having random lengths and extending in one direction are arranged by being filled two-dimensionally.

An average pitch Pm of the structures 12a is preferably smaller than or equal to 200 nm. When the average pitch Pm is smaller than or equal to 200 nm, transparency can be ensured.

Herein, the average pitch Pm of the structures 12a is obtained as follows.

First, the minute concave-convex surface S is observed with an atomic force microscope (AFM). Second, arbitrary two adjacent structures 12a are chosen from a cross-sectional profile of the obtained AFM image and a distance between these structures (shortest distance between tops of the minimum iteration structure) is obtained as a pitch. Next, this procedure is conducted at 10 arbitrary places on the minute concave-convex surface S so as to obtain pitches P1, P2, . . . , P10. Next, these pitches P1, P2, . . . , P10 are simply averaged (arithmetic average) so as to obtain the average pitch Pm.

An arithmetic average roughness Ra of the minute concave-convex surface S is preferably smaller than or equal to 25 nm. If the arithmetic average roughness Ra exceeds 25 nm, the optical property thereof deteriorates. If the arithmetic average roughness Ra is smaller than or equal to 25 nm, on the other hand, it is possible to suppress an increase in haze. Therefore, when the optical element or the minute structure layer 12 thereof is applied to a display surface of a display device, it is possible to suppress a decrease in the display quality thereof caused by haze.

Herein, the arithmetic average roughness Ra of the minute concave-convex surface S is obtained as follows. First, the minute concave-convex surface S in a field of view of 3 μm×3 μm is observed with the AFM.

Second, an arithmetic average roughness ra is obtained from a cross-sectional profile of the obtained AFM image. Next, this procedure is conducted at 10 arbitrary places on the minute concave-convex surface S so as to obtain ra1, ra2, . . . , ra10. Next, these values ra1, ra2, . . . , ra10 are simply averaged (arithmetic average) so as to obtain the arithmetic average roughness Ra.

Haze is preferably smaller than or equal to 10%. If haze exceeds 10%, the optical property thereof deteriorates. More specifically, when the optical element or the minute structure layer 12 thereof is applied to a display surface of a display device for example, the display quality thereof deteriorates. Herein, haze means total haze (sum of surface haze and internal haze).

### [Configuration of Master]

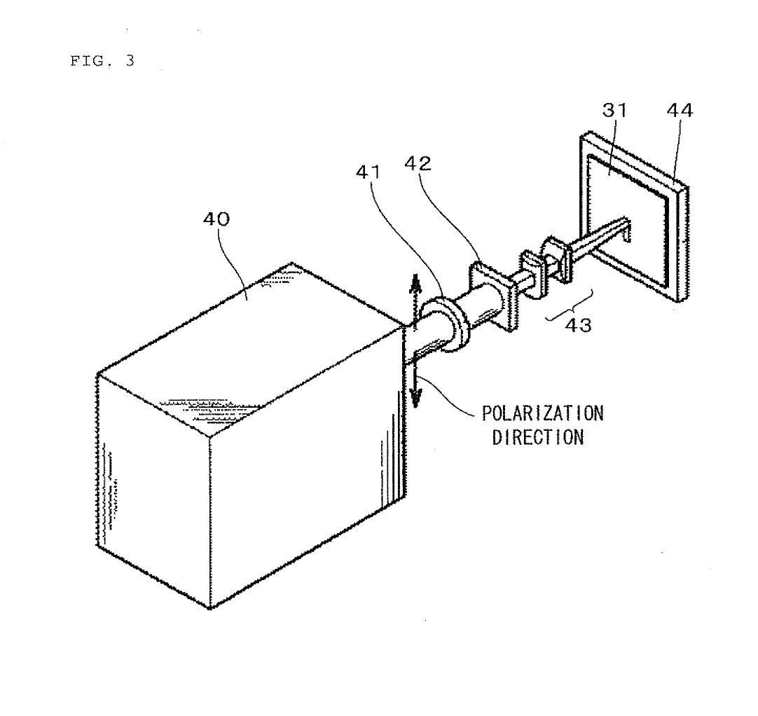

FIG. 2A is a plan view illustrating an exemplary configuration of a plate-shaped master. FIG. 2B is a cross-sectional view taken along the line a-a shown in FIG. 2A. FIG. 2C is a cross-sectional view showing a portion of FIG. 2B in an enlarged manner. The plate-shaped master 31 is a master for producing the optical element having the above-described configuration. More specifically, it is a master for shaping the plurality of structures 12a on the surface of the above-described base member. The master 31 has a surface provided with a minute concave-convex structure, for example. The surface thereof serves as a shaping surface used for shaping the plurality of structures 12a on a surface of a base member. Provided on the shaping surface are a plurality of structures 32, for example. The structures 32 each have a concave shape with respect to the shaping surface. A metallic material can be employed as a material for the master 31. For example, Ni, NiP, Cr, Cu, Al, Fe, or an alloy thereof can be used as such a metallic material. A stainless steel (SUS) is preferably employed as such an alloy. Examples of such a stainless steel (SUS) may include, without being limited to, SUS304 and SUS420J2.

The plurality of structures 32 provided on the shaping surface of the plate-shaped master 31 and the plurality of structures 12a provided on the surface of the above-described base member 11 have an inverted concave-convex relationship. In other words, the arrangement, size, shape, arrangement pitch, height, and the like of the structures 32 of the plate-shaped master 31 are the same as those of the structures 12a of the base member 11.

### [Configuration of Laser Processing Device]

FIG. 3 is a schematic view illustrating an exemplary configuration of a laser processing device for producing the plate-shaped master. A laser main unit 40 may be IFRIT (trade name) manufactured by Cyber Laser Inc., for example. A laser wavelength used in laser processing may be 800 nm, for example. Note however that the laser wavelength used in laser processing may be 400 nm, 266 nm, or the like. A larger repetition frequency is preferable in view of the processing time and the thus formed narrowed pitch of the concave-convex shape. The repetition frequency is preferably greater than or equal to 1000 Hz. A shorter laser pulse width is preferable, and it is preferably in a range between about 200 femtoseconds (10⁻¹⁵ second) and about 1 picosecond (10⁻¹² second).

The laser main unit 40 is designed to emit a laser beam linearly polarized in a vertical direction. Thus, a wave plate 41 (for example, a λ/2 wave plate) is used in the present device, for example, to rotate the polarization direction, thereby obtaining linear polarization or circular polarization in a desired direction. Also the present device employs a rectangular-shaped aperture 42 having an opening in order to take out a portion of a laser beam. Since the intensity distribution of the laser beam is a Gaussian distribution, only a portion near the center of the laser beam is used to obtain a laser beam having a uniform in-plane intensity distribution. Also, the present device is designed to obtain a desired beam size by narrowing down a laser beam by means of two cylindrical lenses 43 provided at right angles thereto. When processing the plated-shaped master 31, a linear stage 44 is moved at a constant speed.

A laser beam spot irradiated onto the master 31 preferably has a rectangular shape. The shaping of the beam spot can be achieved, for example, by the aperture, the cylindrical lens, and the like. Moreover, it is preferable that the intensity distribution of the beam spot be as uniform as possible. This is because it is desired to uniformize the in-plane distribution of the depths of the concave and convex portions formed in a mold, or the like, as much as possible. A size of the beam spot is generally smaller than an area to be processed. It is therefore necessary to give a concave-convex shape across the entire area to be processed by means of beam scanning.

The master (mold) used for forming the minute concave-convex surface S is formed by drawing a pattern on a base plate made of, for example, a metal such as SUS, NIP, Cu, Al, or Fe with an ultrashort pulse laser with a pulse width smaller than or equal to 1 picosecond (10⁻¹² second), i.e., a femtosecond laser. Moreover, the polarization of the laser beam may be linear polarization, circular polarization, or elliptical polarization. By appropriately setting its laser wavelength, repetition frequency, pulse width, beam spot shape, polarization, laser intensity irradiated onto a sample, laser scanning speed, and the like, it is possible to form a pattern having a desired concave-convex shape.

Examples of parameters that can be varied in order to obtain a desired shape are as follows. A fluence is an energy density (J/cm²) per a pulse and can be obtained with the following expression.

F=P/(fREPT×S)

S=Lx×Ly

F: fluence

P: laser power

fREPT: laser repetition frequency

S: area at laser irradiated position

Lx×Ly: beam size

Note that a pulse number N is the number of pulses irradiated onto one spot and is obtained with the following expression.

N=fREPT×Ly/v

Ly: beam size in laser scanning direction

v: laser scanning speed

Moreover, the material of the master 31 can be changed in order to obtain a desired shape. A shape obtained by laser processing is varied depending on the material of the master 31. Other than employing a metal such as SUS, NiP, Cu, Al, Fe, or the like, a semiconductor material such as DLC (diamond-like carbon), for example, may be coated on the surface of the master. As a method for coating a semiconductor material on the surface of the master, plasma CVD or sputtering, for example, may be employed. Examples of such a coating semiconductor material may include, in addition to DLC, DLC into which fluorine (F) is mixed (hereinafter, referred to as FDLC), titanium nitride, and chromium nitride. The thickness of the coating may be about 1 μm, for example.

### [Method for Producing Optical Element]

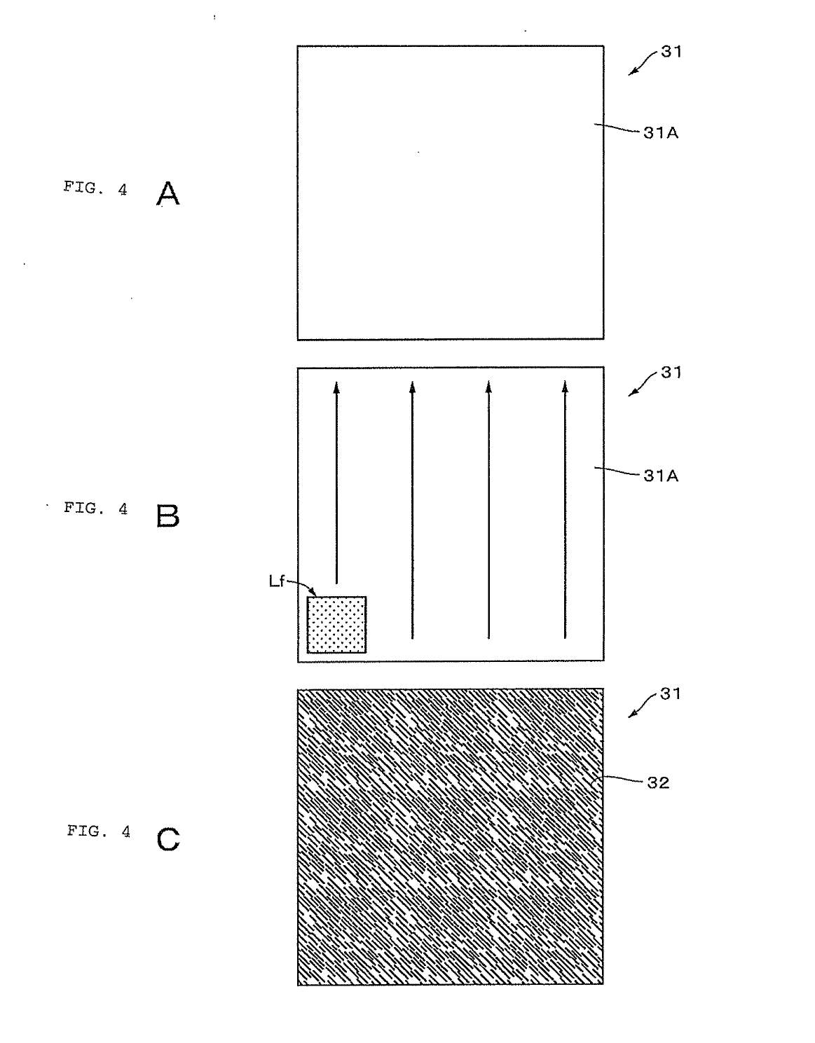

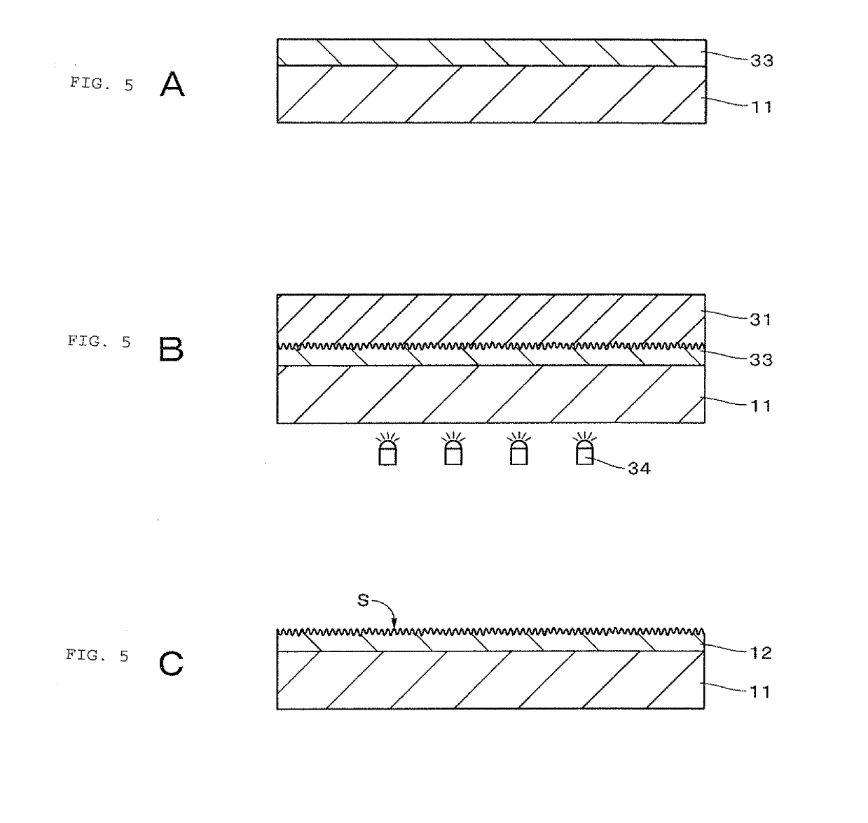

FIGS. 4A to 5C are process diagrams illustrating an example of a method for producing the optical element according to the first embodiment of the present technique.

### (Laser Processing Process)

First, the plate-shaped master 31 is prepared as shown in FIG. 4A. A surface 31A of the master 31, which is a surface to be processed, has a mirror surface, for example. Note that the surface 31A does not always need to have a mirror surface. Alternatively, concave and convex portions finer than those of a transfer pattern may be formed on the surface 31A, or concave and convex portions equivalent to or coarser than those of the transfer pattern may be formed on the surface 31A, for example.

Subsequently, the surface 31A of the master 31 is laser-processed as will be described below by using the laser processing device shown in FIG. 3. First, a pattern is drawn on the surface 31A of the master 31 by using an ultrashort pulse laser with a pulse width smaller than or equal to 1 picosecond (10⁻¹² second), i.e., a femtosecond laser. For example, a femtosecond laser beam Lf is irradiated onto the surface 31A of the master 31 and the irradiated spot is scanned on the surface 31A as shown in FIG. 4B.

By appropriately setting its laser wavelength, repetition frequency, pulse width, beam spot shape, polarization, laser intensity irradiated onto the surface 31A, laser scanning speed, and the like, the plurality of structures 32 having a desired shape are formed as shown in FIG. 4C.

### (Structure Forming Process)

Next, the plate-shaped master 31 obtained as described above is used to transfer its shape to a resin material, thereby forming the plurality of structures 12a on the surface of the base member 11. In this manner, the above-described optical element according to the first embodiment is produced. Examples of such a shape transfer method used may include a transfer method by means of an energy-ray curable resin (hereinafter referred to as an “energy-ray transfer method”), a transfer method by means of a thermosetting resin (hereinafter referred to as a “thermal curing transfer method”), and a transfer method by means of a thermoplastic resin composition (hereinafter referred to as a “thermal transfer method”). Herein, the energy-ray transfer method also includes a 2P transfer method (Photo Polymerization: a shaping method through the use of photo curing). Hereinafter, the structure forming process will be explained separately about the structure forming process by means of the energy-ray transfer method or the thermal curing transfer method and the structure forming process by means of the thermal transfer method.

### [Structure Forming Process by Means of Energy-Ray Transfer Method or Thermal Curing Transfer Method]

### (Process of Preparing Resin Composition)

FIGS. 5A to 5C are process diagrams illustrating an example of the structure forming process by means of the energy-ray transfer method or the thermal curing transfer method. First, a resin composition is dissolved into a solvent for dilution, as needed. At this time, various kinds of additives may be added to the resin composition, if needed. Such dilution with a solvent is performed as needed basis. When dilution is unnecessary, the resin composition may be used without a solvent.

The resin composition includes at least one of an energy-ray curable resin composition and a thermosetting resin composition. The energy-ray curable resin composition refers to a resin composition that can be cured with the irradiation of energy rays. The energy rays represent energy rays that can trigger a radical, cationic, or anionic polymerization reaction, such as electron rays, ultraviolet rays, infrared rays, laser beams, visible rays, ionizing radiation (X-rays, alpha rays, beta rays, gamma rays, or the like), microwaves, high-frequency waves, or the like. If needed, the energy-ray curable resin composition may be mixed and used with other resin composition. For example, the energy-ray curable resin composition may be mixed and used with other curable resin composition such as a thermosetting resin composition. The energy-ray curable resin composition may be an organic-inorganic hybrid material. Alternatively, two or more kinds of energy-ray curable resin compositions may be mixed and used together. A preferably-used energy-ray curable resin composition is an ultraviolet curable resin composition to be cured by ultraviolet rays.

The ultraviolet curable resin composition contains (meth)acrylate having a (meth)acryloyl group and an initiator, for example. The (meth)acryloyl group herein refers to an acryloyl group or a methacryloyl group. Also, (meth)acrylate refers to acrylate or methacrylate. The ultraviolet curable resin composition contains, for example, a monofunctional monomer, a bifunctional monomer, polyfunctional monomer, and the like. More specifically, the ultraviolet curable resin composition is obtained by using a material listed below solely or mixing a plurality of the materials together.

Examples of such a monofunctional monomer may include carboxylic acids (acrylic acid), hydroxy-compounds (2-hydroxyethyl acrylate, 2-hydroxypropyl acrylate, 4-hydroxybutyl acrylate), alkyl, alicycles (isobutyl acrylate, t-butyl acrylate, isooctyl acrylate, lauryl acrylate, stearyl acrylate, isobornyl acrylate, cyclohexyl acrylate), other functional monomers (2-methoxyethyl acrylate, methoxyethylene glycol acrylate, 2-ethoxyethyl acrylate, tetrahydrofurfuryl acrylate, benzyl acrylate, ethylcarbitol acrylate, phenoxyethyl acrylate, N,N-dimethylaminoethyl acrylate, N,N-dimethylaminopropylacryl amide, N,N-dimethylacrylamide, acryloyl morpholine, N-isopropyl acrylamide, N,N-diethyl acrylamide, N-vinylpyrrolidone, 2-(perfluorooctyl)ethylacrylate, 3-perfluorohexyl-2-hydroxypropyl acrylate, 3-perfluorooctyl-2-hydroxypropyl acrylate, 2-(perfluorodecyl)ethylacrylate, 2-(perfluoro-3-methylbutyl)ethylacrylate), 2,4,6-tribromophenol acrylate, 2,4,6-tribromophenol methacrylate, 2-(2,4,6-tribromophenoxy)ethylacrylate), and 2-ethylhexyl acrylate.

Examples of the bifunctional monomer may include tri(propylene glycol)diacrylate, trimethylolpropane diallyl ether, and urethane acrylate.

Examples of the polyfunctional monomer may include trimethylolpropane triacrylate, dipentaerythritol penia and hexaacrylate, and ditrimethylolpropane tetraacrylate.

Examples of the initiator may include 2,2-dimethoxy-1,2-diphenylethane-1-one, 1-hydroxy-cyclohexyl phenyl ketone, and 2-hydroxy-2-methyl-1-phenylpropane-1-one.

A solvent used is blended into the resin composition in view of the coating property and stability of the resin composition, the smoothness of the coated film, and the like, for example. Examples of such a solvent may include water and organic solvents. More specifically, it is possible to employ one kind of or two or more kinds blended together of aromatic solvents such as toluene and xylene; alcohol solvents such as methyl alcohol, ethyl alcohol, n-propyl alcohol, iso-propyl alcohol, n-butyl alcohol, iso-butyl alcohol, and propylene glycol monomethyl ether; ester solvents such as methyl acetate, ethyl acetate, butyl acetate, and cellosolve acetate; ketone solvents such as acetone, methyl ethyl ketone, methyl isobutyl ketone, and cyclohexanone; glycol ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; glycol ether esters such as 2-methoxyethyl acetate, 2-ethoxyethyl acetate, 2-butoxyethyl acetate, and propylene glycol methyl ether acetate; chlorinated solvents such as chloroform, dichloromethane, trichloromethane, and methylene chloride; ether solvents such as tetrahydrofuran, diethyl ether, 1,4-dioxane, and 1,3-dioxolane; N-methylpyrrolidone, dimethylformamide, dimethylsulfoxide, dimethylacetamide, and the like, for example. In order to prevent drying spots or cracks on the coated surface, a high-boiling solvent may be further added to control the evaporation rate of the solvent. Examples of such a solvent may include butyl cellosolve, diacetone alcohol, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, and methyl glycol. These solvents may be employed independently or in combination thereof.

### (Coating Process)

Next, a prepared resin composition 33 is coated or printed on a surface of the base member 11 as shown in FIG. 5A. As the coating method thereof, wire-bar coating, blade coating, spin coating, reverse roll coating, die coating, spray coating, roll coating, gravure coating, microgravure coating, lip coating, air knife coating, curtain coating, comma coating, a dipping method, or the like can be employed for example.

As the printing method thereof, a letterpress printing method, an offset printing method, a gravure printing method, an intaglio printing method, a rubber plate printing method, an ink-jet method, a screen printing method, or the like can be employed for example.

### (Drying Process)

Next, when the resin composition 33 contains a solvent, the resin composition is dried as needed in order to volatilize the solvent. Drying conditions are not limited to particular conditions. It is possible to employ air drying or artificial drying with which a drying temperature, a drying time, and the like are controlled.

If the surface of the coating material is blown when dried, however, it is preferably performed while preventing the generation of wind ripples on the surface of the coated film. The drying temperature and the drying time can be appropriately determined on the basis of the boiling point of the solvent contained in the coating material. In such a case, the drying temperature and the drying time are preferably selected in consideration of the heat resistance of the base member 11 within a range preventing the deformation of the base member 11 due to the thermal contraction thereof.

### (Curing Process)

Next, as shown in FIG. 5B, the plate-shaped master 31 and the resin composition 33 coated on the surface of the base member 11 are brought into close contact with each other and the resin composition 33 is then cured. Thereafter, the base member 11 integrated with the cured resin composition 33 is peeled off. As a result, there is obtained the optical element in which the plurality of structures 12a are formed on the surface of the base member 11 as shown in FIG. 5C. At this time, the basal layer 12b may be further formed between the structures 12a and the base member 11, if necessary.

Here, the curing method varies depending on the kind of the resin composition 33. When an energy-ray curable resin composition is used as the resin composition 33, the plate-shaped master 31 is pressed against the resin composition 33 so as to bring them into close contact with each other. At the same time, energy rays such as ultraviolet rays (ultraviolet light) are irradiated to the resin composition 33 via the base member 11 from an energy ray source 34 so as to cure the resin composition 33.

The energy ray source 34 is not particularly limited to any energy ray source as long as it can emit energy rays such as electron rays, ultraviolet rays, infrared rays, laser beams, visible rays, ionizing radiation (X-rays, alpha rays, beta rays, gamma rays, or the like), microwaves, or high-frequency waves. In view of production facilities, however, it is preferable to employ an energy ray source capable of emitting ultraviolet rays. It is preferable that the integrated radiation amount thereof be appropriately determined in view of the curing property of the resin composition, the prevention of yellowing of the resin composition or the base member 11, and the like. It is also preferable that the irradiation atmosphere thereof be appropriately selected depending on the kind of the resin composition. Examples of such an irradiation atmosphere may include inert gas atmospheres such as air, nitrogen, and argon.

When the base member 11 is made of a material which prevents energy rays such as ultraviolet rays from transmitting therethrough, the plate-shaped master 31 may be made of a material capable of transmitting energy rays therethrough (for example, quartz) and energy rays may be irradiated to the resin composition 33 from the rear surface (the surface opposite to the shaping surface) of the plate-shaped master 31.

When a thermosetting resin composition is used as the resin composition 33, the plate-shaped master 31 is pressed against the resin composition 33 so as to bring them into close contact with each other. At the same time, the resin composition 33 is heated to the curing temperature thereof by the plate-shaped master 31 so as to cure the resin composition 33. At this time, a cooling roller may be pressed against the surface of the base member 11 opposite to the surface on which the resin composition 33 is coated or printed in order to prevent the base member 11 from being damaged by heat. Herein, the plate-shaped master 31 includes a heat source such as a heater inside thereof or on the rear surface thereof to be capable of heating the resin composition 33 in close contact with the shaping surface of the plate-shaped master 31.

### [Structure Forming Process by Means of Thermal Transfer Method]

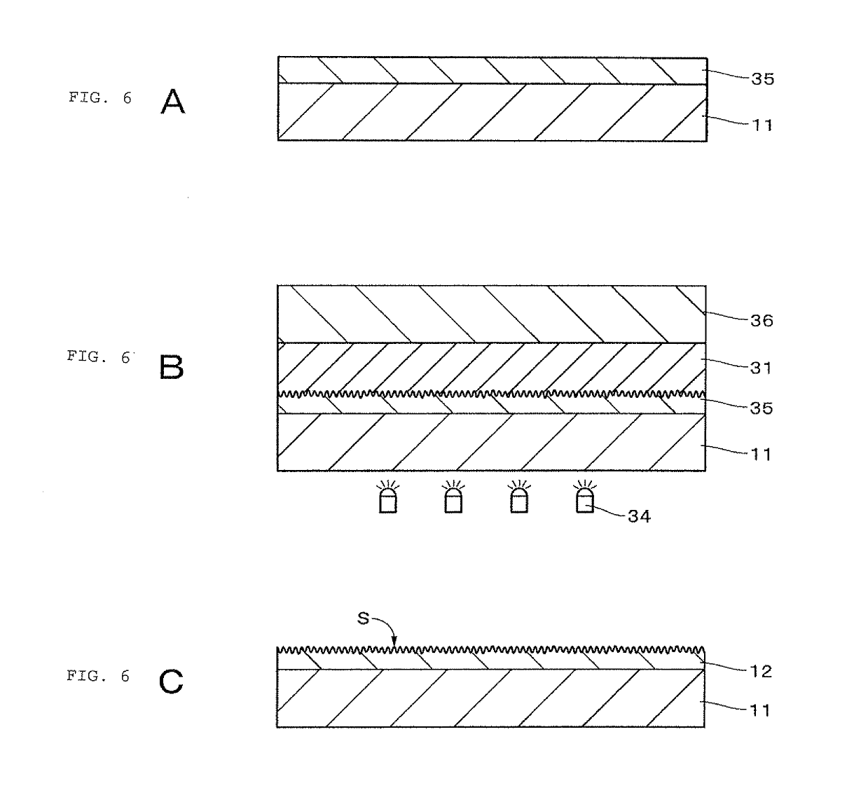

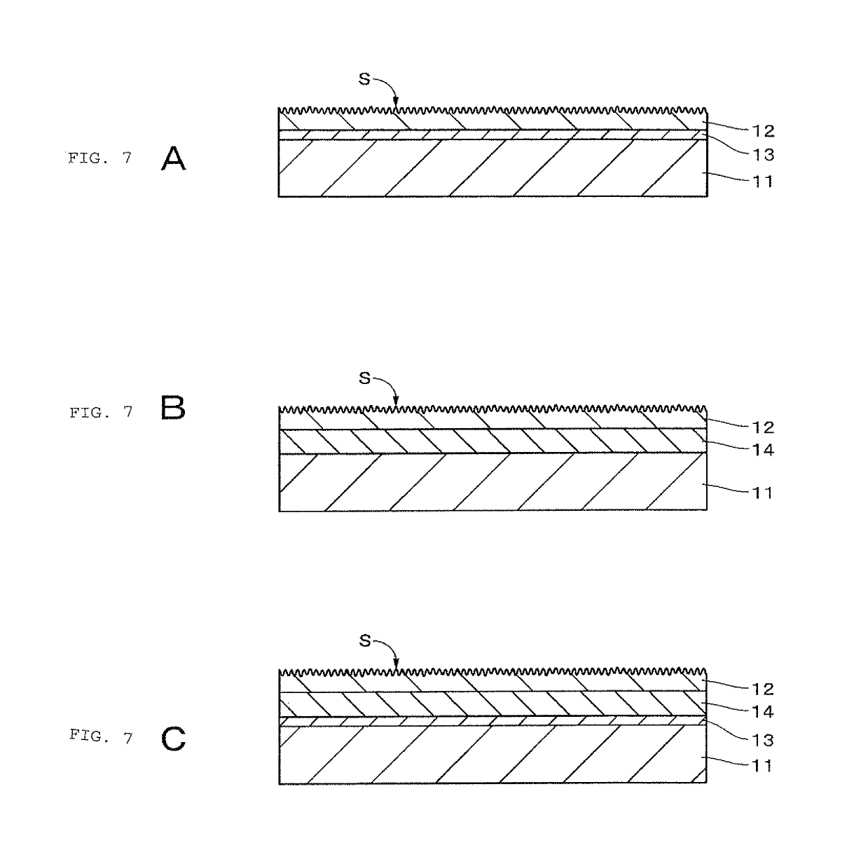

FIGS. 6A to 6C are process diagrams illustrating an example of the structure forming process by means of the thermal transfer method. First, the base member 11 including a resin layer 35, as a transfer layer, provided on a surface thereof is formed as shown in FIG. 6A. The resin layer 35 contains a thermoplastic resin composition, for example.

Next, as shown in FIG. 6B, the plate-shaped master 31 is pressed against the resin layer 35 so as to bring them into close contact with each other. At the same time, the resin layer 35 is heated to a temperature near or equal to or greater than the glass-transition temperature thereof, for example, in order to transfer the shape of the shaping surface of the plate-shaped master 31 to the resin layer 35. Subsequently, the shape-transferred resin layer 35, together with the base member 11, is peeled off from the plate-shaped master 31. As a result, there is obtained the optical element including the plurality of structures 12a formed on the surface of the base member 11 as shown in FIG. 6C. At this time, the basal layer 12b may be further formed between the structures 12a and the base member 11, if necessary. Moreover, the cooling roller may be pressed against the surface of the base member 11 opposite to the surface on which the resin layer 35 is provided in order to prevent the base member 11 from being damaged by heat.

### [Advantageous Effects]

According to the first embodiment, an anti-reflection function can be obtained by forming the plurality of structures 12a on the surface of the base member 11. Therefore, there is no need to form an anti-reflection layer by repeating sequential coating so as to stack a low refractive index layer and a high refractive index layer as in the conventional anti-reflection technique. It is also possible to realize an anti-reflection function without using an expensive material for the low refractive index layer. Therefore, the cost of the anti-reflection layer and a product including the same can be reduced. Moreover, dispersion can be prevented by providing fluctuations in the shape of the minute concave-convex surface S.

A surface or an optical element having an anti-reflection function can be produced by directly transferring a shape to the surface of the base member or transferring a shape to the resin composition coated on the surface of the base member. Therefore, it is possible to produce the surface or the optical element having the anti-reflection function inexpensively.

When the optical element according to the first embodiment or the minute structure layer 12 thereof is applied to a display surface, a product with an improved display quality can be produced inexpensively.

### Modified Examples

Although the configuration including the minute structure layer 12 provided adjacent to the surface of the base member 11 is described as an example in the above-described first embodiment, the configuration of the optical element is not limited to this example. Modified examples of the optical element will be described below.

### First Modified Example

FIG. 7A is a cross-sectional view illustrating an exemplary configuration of an optical element according to the first modified example. As shown in FIG. 7A, this optical element differs from the optical element according to the first embodiment in that an anchor layer 13 is further provided between the base member 11 and the minute structure layer 12. The thus provided anchor layer 13 between the base member 11 and the minute structure layer 12 makes it possible to improve adhesion between the base member 11 and the minute structure layer 12. Alternatively, the plurality of structures 12a may be formed by providing a minute concave-convex structure on a surface of the anchor layer 13 and then providing the minute structure layer 12 so as to follow this concave-convex structure.

The material for the anchor layer 13 can be selected and used from, for example, a wide range of conventionally-known natural polymeric resins and synthetic polymeric resins. Examples of such resins may include transparent thermoplastic resin compositions and transparent curable resin compositions to be cured by ionizing radiation or heat. Examples of such a thermoplastic resin composition may include polyvinyl chloride, a vinyl chloride-vinyl acetate copolymer, poly(methyl methacrylate), nitrocellulose, chlorinated polyethylene, chlorinated polypropylene, ethyl cellulose, and hydroxypropyl methylcellulose. Examples of such a transparent curable resin may include methacrylate, melamine acrylate, urethane acrylate, isocyanate, an epoxy resin, and a polyimide resin. Examples of such ionizing radiation may include electron rays, light (for example, ultraviolet rays, visible rays, or the like), and gamma rays. In view of production facilities, ultraviolet rays are preferable to use.

The material of the anchor layer 13 may further contain an additive. Examples of such an additive may include a surfactant, a viscosity modifier, a dispersant, a cure accelerator catalyst, a plasticizer, and a stabilizer such as an antioxidant or an anti-sulfuration agent.

### Second Modified Example

FIG. 7B is a cross-sectional view showing an exemplary configuration of an optical element according to the second modified example. As shown in FIG. 7B, this optical element differs from the optical element according to the first embodiment in that a hard coat layer 14 is further provided between the base member 11 and the minute structure layer 12. When a resin base member such as a plastic film is used as the base member 11, it is particularly preferable to provide the hard coat layer 14 in this manner. By providing the hard coat layer 14 between the base member 11 and the minute structure layer 12 as described above, the practical property thereof (such as durability or pencil hardness thereof) can be improved. Alternatively, the plurality of structures 12a may be formed by providing a minute concave-convex structure on a surface of the hard coat layer 14 and then providing the minute structure layer 12 so as to follow this concave-convex structure.

The material for the hard coat layer 14 can be selected and used from, for example, a wide range of conventionally-known natural polymeric resins and synthetic polymeric resins. Examples of these resins may include transparent thermoplastic resin compositions and transparent curable resins to be cured by ionizing radiation or heat. Examples of such a thermoplastic resin composition may include polyvinyl chloride, a vinyl chloride-vinyl acetate copolymer, poly(methyl methacrylate), nitrocellulose, chlorinated polyethylene, chlorinated polypropylene, ethyl cellulose, and hydroxypropyl methylcellulose. Examples of such a transparent curable resin may include methacrylate, melamine acrylate, urethane acrylate, isocyanate, an epoxy resin, and a polyimide resin. Examples of such ionizing radiation may include electron rays, light (such as ultraviolet rays or visible rays), and gamma rays. In view of production facilities, ultraviolet rays are preferable to use.

The material of the hard coat layer 14 may further contain an additive. Examples of such an additive may include a surfactant, a viscosity modifier, a dispersant, a cure accelerator catalyst, a plasticizer, and a stabilizer such as an antioxidant or an anti-sulfuration agent. Moreover, in order to impart an AG (Anti-Glare) function to the minute concave-convex surface S, the hard coat layer 14 may further contain light-scattering particles such as organic resin fillers serving to scatter light. In such a case, the light-scattering particles may be protruded from the surface of the hard coat layer 14 or the minute concave-convex surface S of the minute structure layer 12. Alternatively, the light-scattering particles may be covered by the resin contained in the hard coat layer 14 or the minute structure layer 12. The light-scattering particles may or may not be in contact with the base member 11 positioned thereunder. Both of the hard coat layer 14 and the minute structure layer 12 may further contain light-scattering particles. Instead of the AG function, or in addition to the AG function, an AR (Anti-Reflection) function may be imparted to the optical element. The AR function can be imparted, for example, by forming an AR layer on the hard coat layer 14. Examples of such an AR layer may include a single-layer film made of a low refractive index layer and a multi-layer film made of a low refractive index layer and a high refractive index layer stacked in an alternate manner.

### Third Modified Example

FIG. 7C is a cross-sectional view illustrating an exemplary configuration of an optical element according to the third modified example. As shown in FIG. 7C, this optical element differs from the optical element according to the first embodiment in that it further includes the hard coat layer 14 provided between the base member 11 and the minute structure layer 12 and the anchor layer 13 provided between the base member 11 and the hard coat layer 14. When a resin base member such as a plastic film is used as the base member 11, it is particularly preferable to provide the hard coat layer 14 in this manner.

### Fourth Modified Example

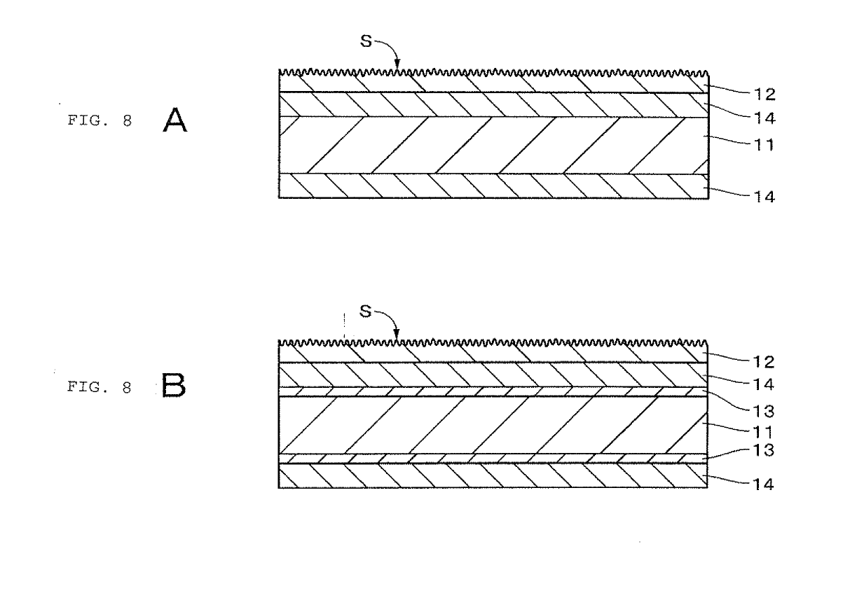

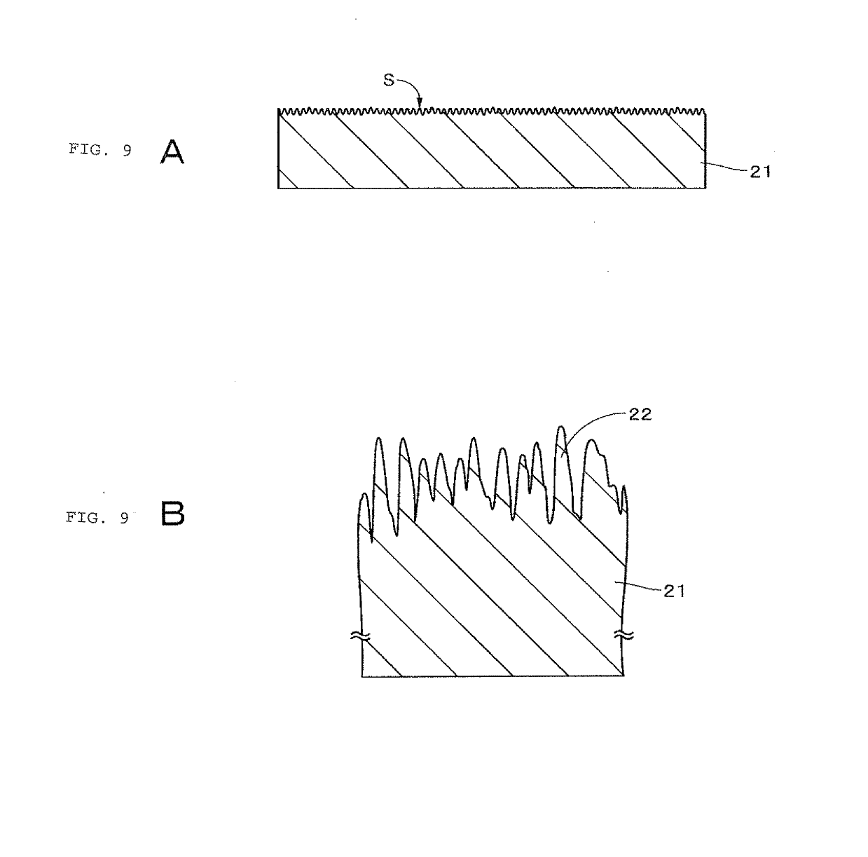

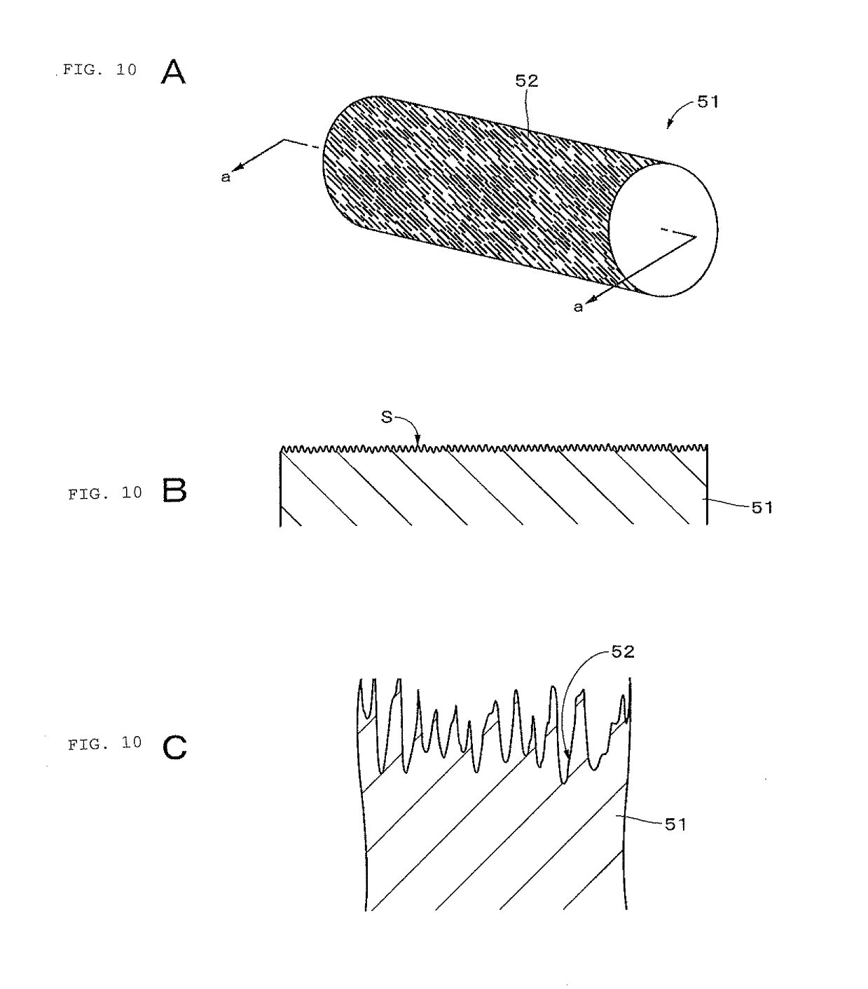

FIG. 8A is a cross-sectional view showing an exemplary configuration of an optical element according to the fourth modified example. As shown in FIG. 8A, this optical element differs from the optical element according to the first embodiment in that the hard coat layers 14 are further provided on respective sides of the base member 11. The minute structure layer 12 is provided on a surface of one of the hard coat layers 14 provided on both sides of the base member 11. When a resin base member such as a plastic film is used as the base member 11, it is particularly preferable to provide the hard coat layers 14 in this manner.

### Fifth Modified Example

FIG. 8B is a cross-sectional view showing an exemplary configuration of an optical element according to the fifth modified example. As shown in FIG. 8B, this optical element differs from the optical element according to the first embodiment in that the anchor layer 13 and the hard coat layer 14 are further provided on each of both sides of the base member 11. The anchor layer 13 is provided between the base member 11 and the hard coat layer 14. The minute structure layer 12 is provided on a surface of one of the hard coat layers 14 provided on both sides of the base member 11. When a resin base member such as a plastic film is used as the base member 11, it is particularly preferable to provide the hard coat layers 14 in this manner.

### 2. Second Embodiment

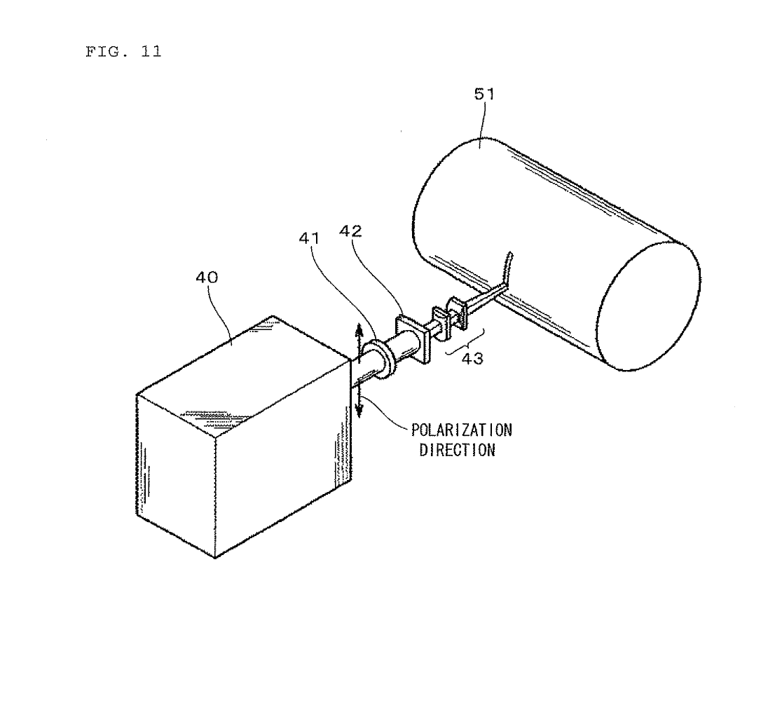

FIG. 9A is a cross-sectional view showing an exemplary configuration of an optical element according to the second embodiment of the present technique. FIG. 9B is a cross-sectional view illustrating a portion of FIG. 9A in an enlarged manner. This optical element differs from that of the first embodiment in that a base member 21 and a plurality of structures 22 are integrally formed as shown in FIGS. 9A and 9B. A preferred material of the base member 21 and the structures 22 is a material containing a thermoplastic resin composition.

As a method for producing the optical element, a melt extrusion method, a transfer method, or the like can be used for example. An example of the melt extrusion method may be a method such that immediately after a thermoplastic resin composition is discharged from a die in a film form or the like, it is nipped by two rollers so as to transfer shapes of roller surfaces to the resin material. Here, a roller master can be used as one of the two rollers. The roller master will be described later. An example of the transfer method may be a thermal transfer method such that a shaping surface of a master is pressed against a base member and the base member is heated to a temperature near or equal to or greater than the glass-transition temperature thereof in order to transfer the shape of the shaping surface of the master to the base member. The above-described plate-shaped master 31 in the first embodiment can be used as the master.

### [Advantageous Effects]

Since the base member 21 and the plurality of structures 22 are integrally formed in the second embodiment, it is possible to achieve a simplified configuration of the optical element. Moreover, when the base member 21 and the plurality of structures 22 have transparency, it is possible to suppress interfacial reflection between the base member 21 and the plurality of structures 22.

### 3. Third Embodiment

The third embodiment is different from the first embodiment in that an optical element is produced by using the roller master.

### [Configuration of Master]

FIG. 10A is a perspective view showing an exemplary configuration of a roller master. FIG. 10B is a cross-sectional view taken along the line a-a shown in FIG. 10A. FIG. 10C is a cross-sectional view illustrating a portion of FIG. 10B in an enlarged manner. The roller master 51 is a master for producing an optical element having the above-described configuration. More specifically, it is a master for shaping the plurality of structures 12a on the above-described surface of the base member. The roller master 51 has a columnar or cylindrical shape, for example, and the columnar surface thereof or the cylindrical surface thereof serves as a shaping surface for shaping the plurality of structures 12a on the surface of the base member. This shaping surface is provided with a plurality of structures 52, for example. The structures 52 each have a concave shape with respect to the shaping surface.

The plurality of structures 52 provided on the shaping surface of the roller master 51 and the plurality of structures 12a provided on the surface of the base member 11 have an inverted concave-convex relationship. In other words, the arrangement, size, shape, arrangement pitch, height, and the like of the structures 52 of the roller master 51 are the same as those of the structures 12a of the base member 11.

### [Configuration of Laser Processing Device]

FIG. 11 is a schematic view illustrating an exemplary configuration of a laser processing device for producing the roller master. This laser processing device is the same as that of the above-described first embodiment except that it includes a structure for rotating the roller master 51 instead of the linear stage 44.

### [Method for Producing Optical Element]

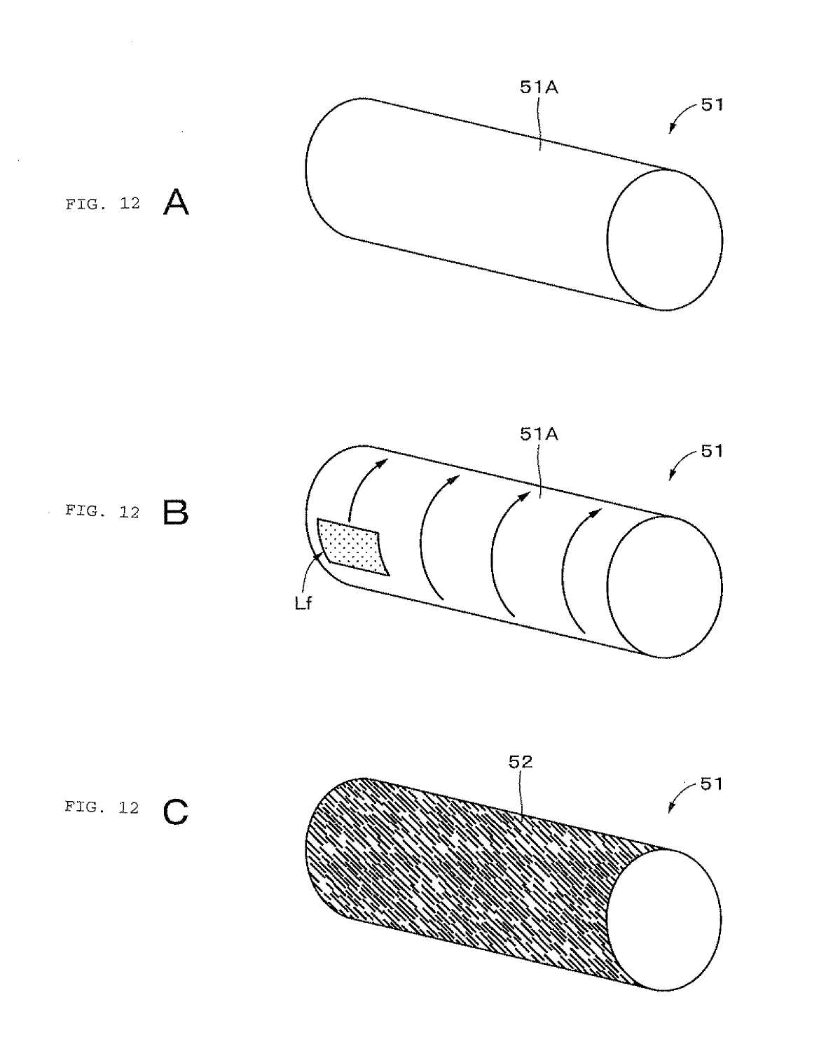

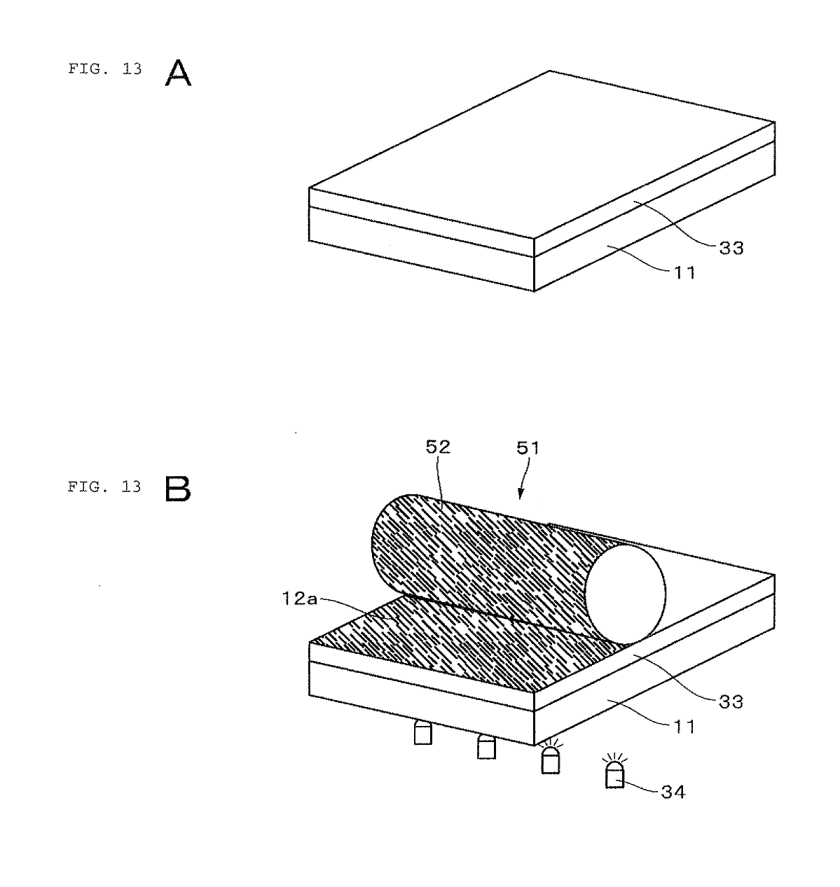

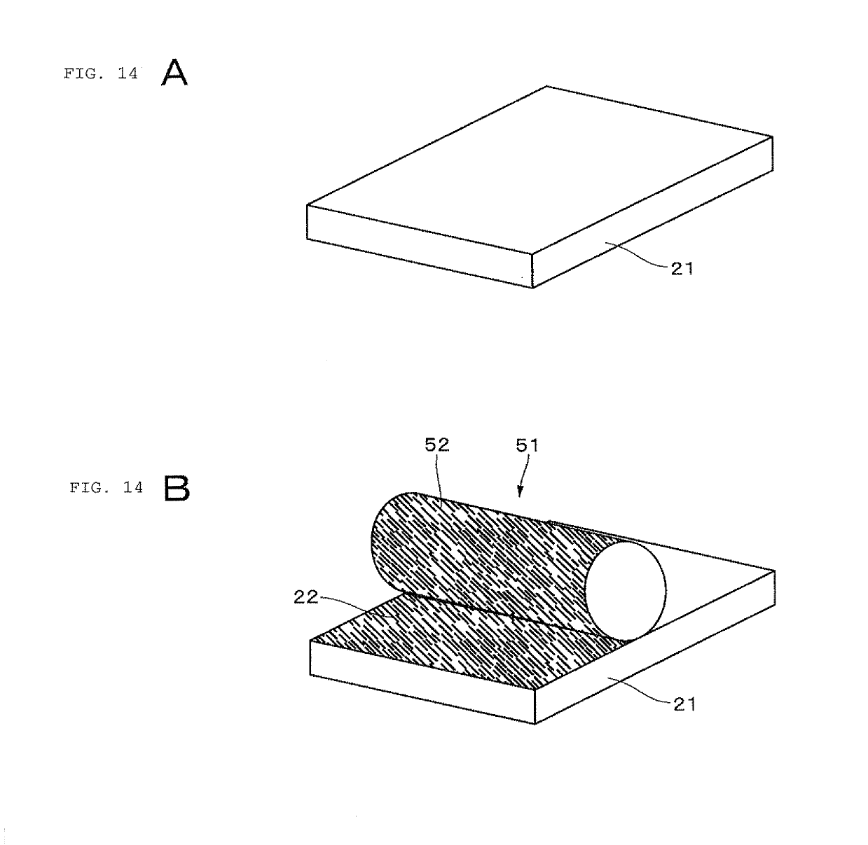

FIGS. 12A to 14B are process diagrams illustrating an example of a method for producing an optical element according to the third embodiment of the present technique. Note that the same reference numerals will be used in the third embodiment to designate the same elements as those of the first or second embodiment and the description thereof will be omitted.

### (Laser Processing Process)

First, the columnar or cylindrical roller master 51 is prepared as shown in FIG. 12A. A surface 51A of the roller master 51, which is a surface to be processed, has a mirror surface, for example. Note that the surface 51A does not always need to have a mirror surface. Alternatively, concave and convex portions finer than those of a transfer pattern may be formed on the surface 51A, or concave and convex portions equivalent to or coarser than those of the transfer pattern may be formed on the surface 51A, for example.

Subsequently, the surface 51A of the roller master 51 is laser-processed as will be described below by using the laser processing device shown in FIG. 11. First, a pattern is drawn on the surface 51A of the roller master 51 by using an ultrashort pulse laser with a pulse width smaller than or equal to 1 picosecond (10⁻¹² second), i.e., a femtosecond laser. For example, a femtosecond laser beam Lf is irradiated onto the surface 51A of the roller master 51 and the irradiated spot is scanned on the surface 51A as shown in FIG. 12B.

By appropriately setting its laser wavelength, repetition frequency, pulse width, beam spot shape, polarization, laser intensity irradiated onto the surface 51A, laser scanning speed, and the like, the plurality of structures 52 having a desired shape are formed as shown in FIG. 12C.

### (Structure Forming Process)

Next, the roller master 51 obtained as described above is used to transfer its shape to a resin material, thereby forming the plurality of structures 12a on the surface of the base member 11. In this manner, the above-described optical element according to the first embodiment is produced. Examples of such a shape transfer method may include an energy-ray transfer method, a thermal curing transfer method, and a thermal transfer method. Hereinafter, the structure forming process will be explained separately about the structure forming process by means of the energy-ray transfer method or the thermal curing transfer method and the structure forming process by means of the thermal transfer method.

### [Structure Forming Process by Means of Energy-Ray Transfer Method or Thermal Curing Transfer Method]

### (Process of Preparing Resin Composition)

FIGS. 13A and 13B are process diagrams illustrating an example of the structure forming process by means of the energy-ray transfer method or the thermal curing transfer method. First, a resin composition is dissolved into a solvent for dilution, as needed. At this time, various kinds of additives may be added to the resin composition, if needed. Such dilution with a solvent is performed as needed basis. If dilution is unnecessary, the resin composition may be used without a solvent.

### (Coating Process)

Next, the prepared resin composition 33 is coated or printed on a surface of the base member 11 as shown in FIG. 13A.

### (Drying Process)

Next, when the resin composition 33 contains a solvent, the resin composition is dried as needed in order to volatilize the solvent.

### (Curing Process)

Next, as shown in FIG. 13B, the roller master 51 and the resin composition 33 coated on the surface of the base member 11 are brought into close contact with each other and the resin composition 33 is then cured. Thereafter, the base member 11 integrated with the cured resin composition 33 is peeled off from the roller master 51. As a result, there is obtained the optical element including the plurality of structures 12a formed on the surface of the base member 11 as shown in FIG. 13B. At this time, the basal layer 12b may be further formed between the structures 12a and the base member 11 if necessary.

Here, the curing method varies depending on the kind of the resin composition 33. When an energy-ray curable resin composition is used as the resin composition 33, the roller master 51 is pressed against the resin composition 33 so as to bring them into close contact with each other. At the same time, energy rays such as ultraviolet rays (ultraviolet light) are irradiated to the resin composition 33 from the energy ray source 34 so as to cure the resin composition 33.

When the base member 11 is made of a material which prevents energy rays such as ultraviolet rays from transmitting therethrough, the roller master 51 may be made of a material capable of transmitting energy rays therethrough (for example, quartz) and energy rays may be irradiated to the resin composition 33 from the inside of the roller master 51.

When a thermosetting resin composition is used as the resin composition 33, the roller master 51 is pressed against the resin composition 33 so as to bring them into close contact with each other. At the same time, the resin composition 33 is heated to the curing temperature thereof by the roller master 51 so as to cure the resin composition 33. At this time, the cooling roller may be pressed against the surface of the base member 11 opposite to the surface on which the resin composition 33 is coated or printed in order to prevent the base member 11 from being damaged by heat. Herein, the roller master 51 includes a heat source such as a heater inside thereof and is configured to be capable of heating the resin composition 33 in close contact with the shaping surface of the roller master 51.

### [Structure Forming Process by Means of Thermal Transfer Method]

FIGS. 14A and 14B are process diagrams illustrating an example of the structure forming process by means of the thermal transfer method. First, the base member 21 is formed as shown in FIG. 14A. The base member 21 contains a thermoplastic resin composition, for example.

Next, as shown in FIG. 14B, the roller master 51 is pressed against the base member 21 so as to bring them into close contact with each other. At the same time, the base member 21 is heated to a temperature near or equal to or greater than the glass-transition temperature thereof, for example, in order to transfer the shape of the shaping surface of the roller master 51 to the base member 21. Subsequently, the shape-transferred base member 21 is peeled off from the roller master 51. As a result, there is obtained the optical element including the plurality of structures 22 formed on the surface of the base member 21. At this time, the cooling roller may be pressed against the surface of the base member 21 opposite to the surface on which the plurality of structures 22 are formed in order to prevent the base member 21 from being damaged by heat.

Although a case in which the roller master 51 is pressed against the base member 21 to form the structures 22 on the surface of the base member 21 is described in the above-described example of the thermal transfer method, the thermal transfer method is not limited to this example.

For example, in the same manner as the above-described transfer method in the first embodiment, the resin layer 35 may be formed on the surface of the base member 11 and the roller master 51 may be pressed against the resin layer 35 to form the structures 12a on the surface of the resin layer 35.

### [Advantageous Effects]

According to the third embodiment, since the roller master 51 is used as a master, it is possible to produce an optical element with a roll-to-roll process or the like. Thus, the productivity of the optical element can be improved.

### 4. Fourth Embodiment

Each of FIGS. 15A and 15B is a cross-sectional view illustrating an exemplary configuration of a transparent conductive element according to the fourth embodiment of the present technique. The transparent conductive element includes a substrate 16 and a transparent conductive layer 15 provided on a surface of the substrate 16. FIG. 15A shows a configuration example in which the transparent conductive layer 15 is provided on the surface of the substrate 16 on the side of the minute structure layer 12. FIG. 15B, on the other hand, shows a configuration example in which the transparent conductive layer 15 is provided on the surface of the substrate 16 opposite to the side of the minute structure layer 12. The above-described optical element according to the first or second embodiment can be used as the substrate 16. Note that each of FIGS. 15A and 15B shows an example using the optical element of the first embodiment as the substrate 16.

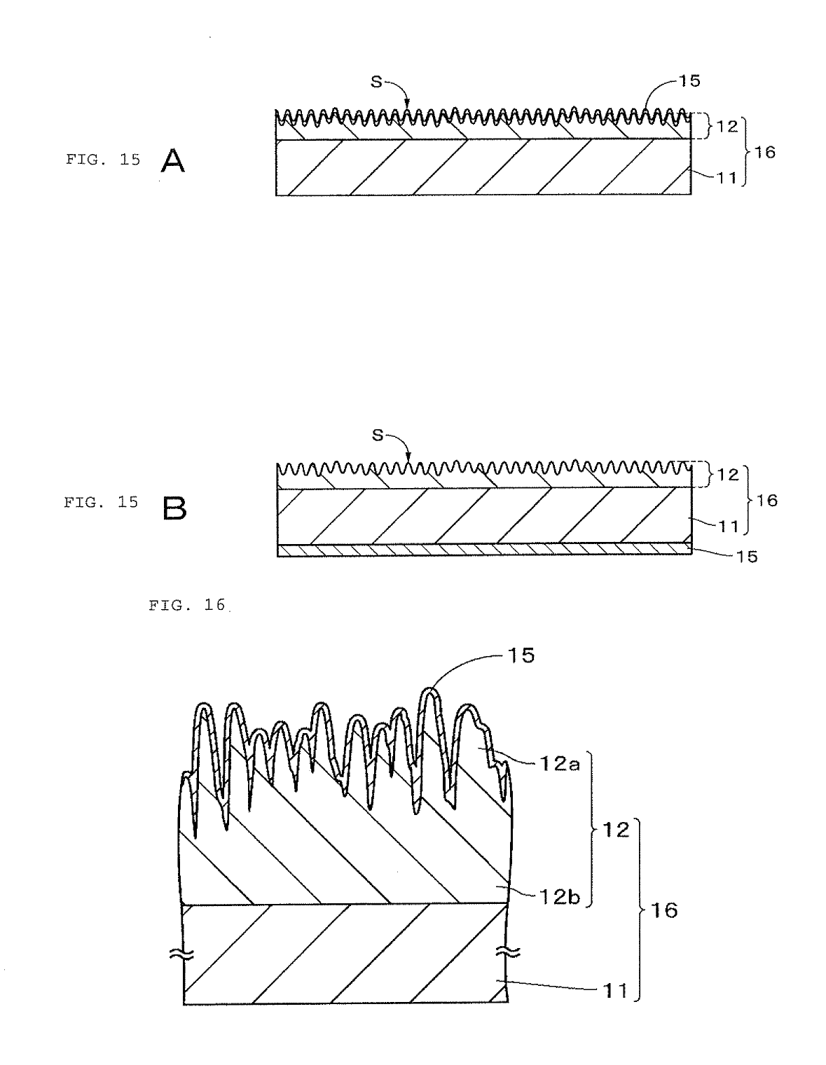

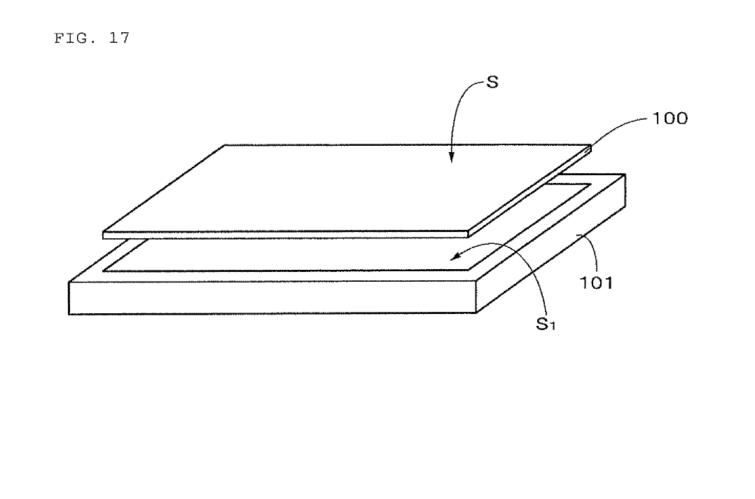

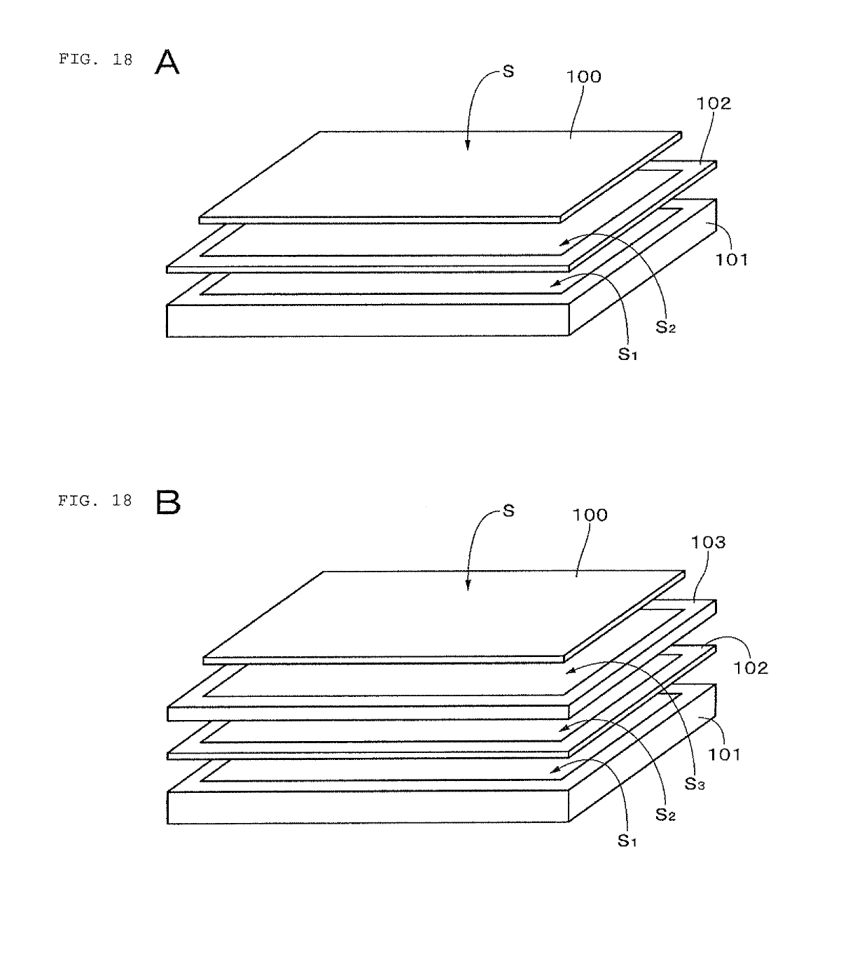

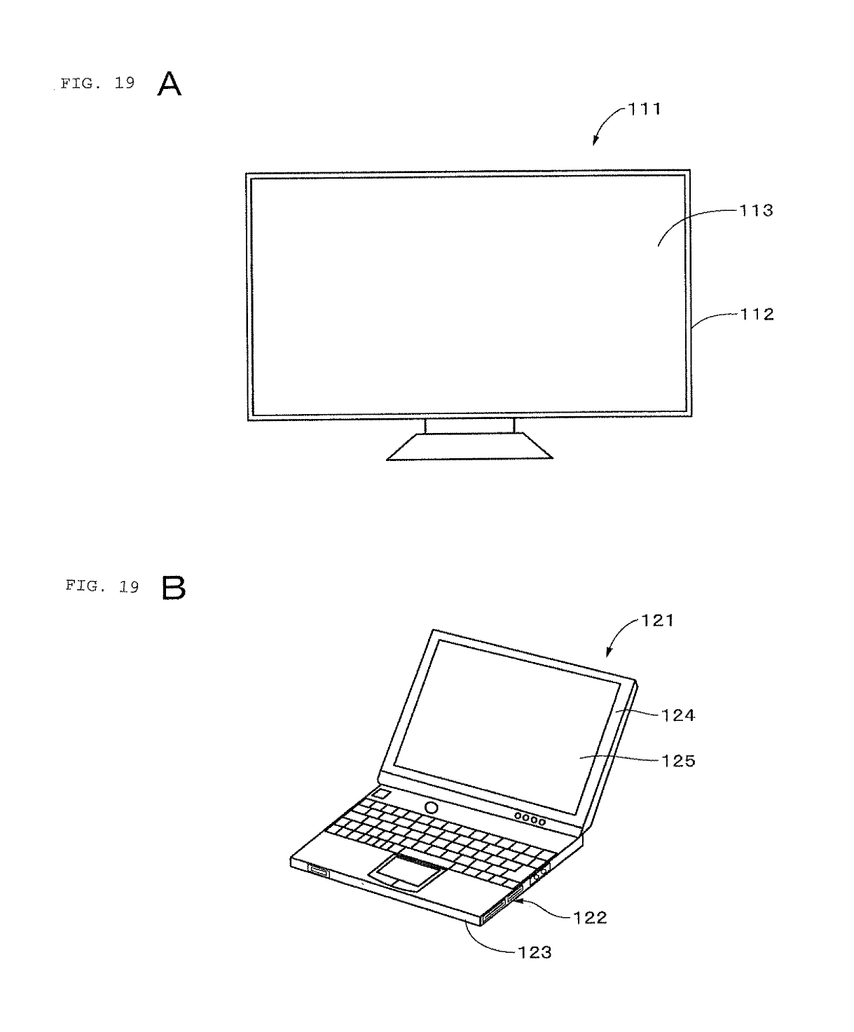

FIG. 16 is a cross-sectional view illustrating a portion of FIG. 15A in an enlarged manner. If the transparent conductive layer 15 is provided on the surface of the substrate 16 on the side of the minute structure layer 12, the transparent conductive layer 15 is preferably provided so as to follow the surface of the minute structure layer 12, i.e., the surface of the structures 12a as shown in FIG. 16. This is because the anti-reflection function thereof can be thereby improved.

The transparent conductive layer 15 may be a transparent electrode having a predetermined electrode pattern. Examples of such an electrode pattern may include, without being limited to, a stripe shape. An overcoat layer may be further provided on the surface of the transparent conductive layer 15, if needed. A hard coat layer and/or an anchor layer may be further provided between the base member 11 and the minute structure layer 12, if needed. This optical element is suitable for use as an electrode substrate of a touch panel (input device) or a display device.

For example, one or more kinds selected from the group consisting of metal oxide materials having electrical conductivity, metallic materials, carbon materials, conductive polymers, and the like can be used as the material for the transparent conductive layer 15. Examples of such metal oxide materials may include indium tin oxide (ITO), zinc oxide, indium oxide, antimony-added tin oxide, fluoridated tin oxide, aluminum-added zinc oxide, gallium-added zinc oxide, silicon-added zinc oxide, zinc oxide-tin oxide series, indium oxide-tin oxide series, and zinc oxide-indium oxide-magnesium oxide series. Examples of the metallic materials may include metallic nanofillers such as metallic nanoparticles and metallic nanowires. Examples of a specific material therefor may include metals such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead, and alloys thereof. Examples of the carbon materials may include carbon black, carbon fiber, fullerene, graphene, carbon nanotubes, carbon microcoil, and nanohorn. Examples of the conductive polymers may include substituted or unsubstituted polyaniline, polypyrrole, polythiophene, and a (co)polymer made of one kind or two kinds selected from these substances.

Examples of a method for forming the transparent conductive layer 15 may include, without being limited to, a PVD method such as sputtering, vacuum deposition, or ion plating, a CVD method, a coating method, and a printing method.

### [Advantageous Effects]

According to the fourth embodiment, since the transparent conductive layer 15 is provided on the surface of the optical element according to the first or second embodiment, it is possible to provide the transparent conductive element having an anti-reflection function. When the transparent conductive layer 15 is provided so as to follow the minute concave-convex surface S of the optical element, a particularly excellent anti-reflection function can be obtained.

### 5. Fifth Embodiment

FIG. 17 is a perspective view illustrating an exemplary configuration of a display device according to the fifth embodiment of the present technique. As shown in FIG. 17, an optical body 100 is provided on a display surface S₁ of a display device 101. A minute structure layer or an optical element is used as the optical body 100, for example. The minute structure layer 12 according to the first embodiment, for example, may be used as such a minute structure layer. The optical element according to the first or second embodiment, for example, may be used as such an optical element. If an optical element is used as the optical body, it is possible to employ a configuration such that the optical element is adhered to the display surface S₁ of the display device 101 via an adhesive layer. If such a configuration is employed, a sheet having transparency and flexibility, or the like, is preferably used as the base member 11 of the optical element.

Any of various display devices such as a liquid crystal display, a cathode ray tube (CRT) display, a plasma display panel (PDP), an electro luminescence (EL) display, and a surface-conduction electron-emitter display (SED), for example, can be used as the display device 101. If the display device 101 includes an electrode substrate, the optical element (transparent conductive element) according to the third embodiment may be used as the electrode substrate.

### [Advantageous Effects]

According to the fifth embodiment, since the minute concave-convex surface S can be employed as the display surface S₁ of the display device 101, an anti-reflection function can be imparted to the display surface S₁ of the display device 101. The display quality of the display device 101 can be thereby improved.

### 6. Sixth Embodiment

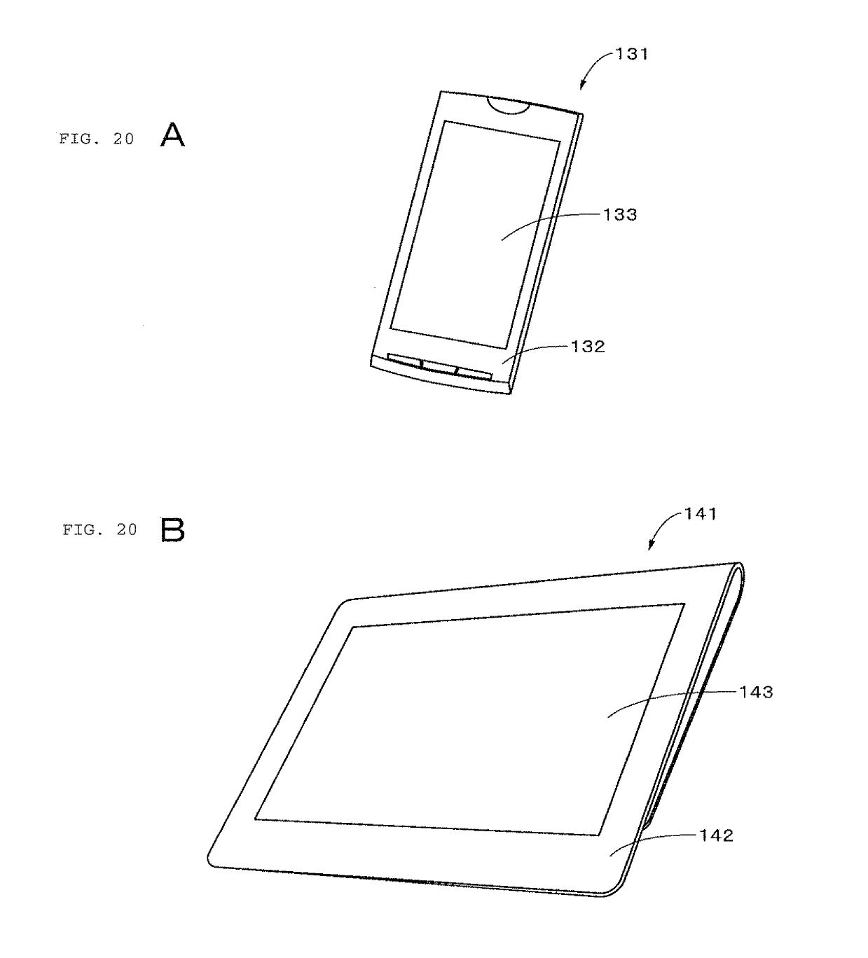

FIG. 18A is a perspective view illustrating an exemplary configuration of an input device according to the sixth embodiment of the present technique. As shown in FIG. 18A, an input device 102 is provided on the display surface S₁ of the display device 101. Also, the optical body 100 is provided on an input surface S₂ of the input device 102. The display device 101 and the input device 102 are adhered together via an adhesive layer made of an adhesive or the like, for example. A minute structure layer or an optical element is used as the optical body 100, for example. The minute structure layer 12 according to the first embodiment, for example, may be used as such a minute structure layer. The optical element according to the first or second embodiment, for example, may be used as such an optical element. If an optical element is used as the optical body, it is possible to employ a configuration such that the optical element is adhered to the input surface S₂ of the input device 102 via an adhesive layer. If such a configuration is employed, a sheet having transparency and flexibility, or the like, is preferably used as the base member 11 of the optical element.

A resistive touch panel or a capacitive touch panel, for example, can be used as the input device 102. Note however that a type of the touch panel is not limited thereto. Examples of a resistive touch panel may include a matrix resistive touch panel. Examples of a capacitive touch panel may include a wire sensor or ITO grid projection type capacitive touch panel. If the input device 102 includes an electrode substrate, the optical element (transparent conductive element) according to the third embodiment may be used as the electrode substrate.

### [Advantageous Effects]

According to the sixth embodiment, since the minute concave-convex surface S can be employed as the input surface S₂ of the input device 102, an anti-reflection function can be imparted to the input surface S₂ of the input device 102. The display quality of the display device 101 can be thereby improved.

### Modified Example

FIG. 18B is an exploded perspective view illustrating a modified example of the input device according to the sixth embodiment of the present technique. As shown in FIG. 18B, a front panel (surface member) 103 may be further provided on the input surface S₂ of the input device 102. In this case, the optical body 100 is provided on a panel surface S₃ of the front panel 103. The input device 102 and the front panel (surface member) 103 are adhered together by means of an adhesive layer made of an adhesive or the like, for example.

### 7. Seventh Embodiment

An electronic device according to the seventh embodiment of the present technique includes the display device 101 according to the fifth embodiment, the sixth embodiment, or the modified example of the sixth embodiment. A minute structure layer or an optical element, for example, is used as the optical body 100. The minute structure layer 12 according to the first embodiment, for example, may be used as such a minute structure layer. The optical element according to the first or second embodiment, for example, may be used as such an optical element.

An example of the electronic device according to the seventh embodiment of the present technique will now be described below.

FIG. 19A is an external view showing a TV device as an example of the electronic device. A TV device 111 includes a housing 112 and a display device 113 contained in the housing 112. Herein, the display device 113 is identical to the display device 101 according to the fifth embodiment, the sixth embodiment, or the modified example of the sixth embodiment.

FIG. 19B is an external view showing a laptop personal computer as an example of the electronic device. A laptop personal computer 121 includes a computer main unit 122 and a display device 125. The computer main unit 122 and the display device 125 are contained in a housing 123 and a housing 124, respectively. Herein, the display device 125 is identical to the display device 101 according to the fifth embodiment, the sixth embodiment, or the modified example of the sixth embodiment.

FIG. 20A is an external view showing a mobile phone as an example of the electronic device. A mobile phone 131 is what is called a smartphone and includes a housing 132 and a display device 133 contained in the housing 132. Herein, the display device 133 is identical to the display device 101 according to the sixth embodiment or the modified example thereof.

FIG. 20B is an external view showing a tablet computer as an example of the electronic device. A tablet computer 141 includes a housing 142 and a display device 143 contained in the housing 142. Herein, the display device 143 is identical to the display device 101 according to the sixth embodiment or the modified example thereof.

### [Advantageous Effects]

According to the seventh embodiment, the electronic device includes the display device 101 according to the fifth embodiment, the sixth embodiment, or the modified example of the sixth embodiment. Thus, the display quality of the electronic device can be improved.

### 8. Eighth Embodiment

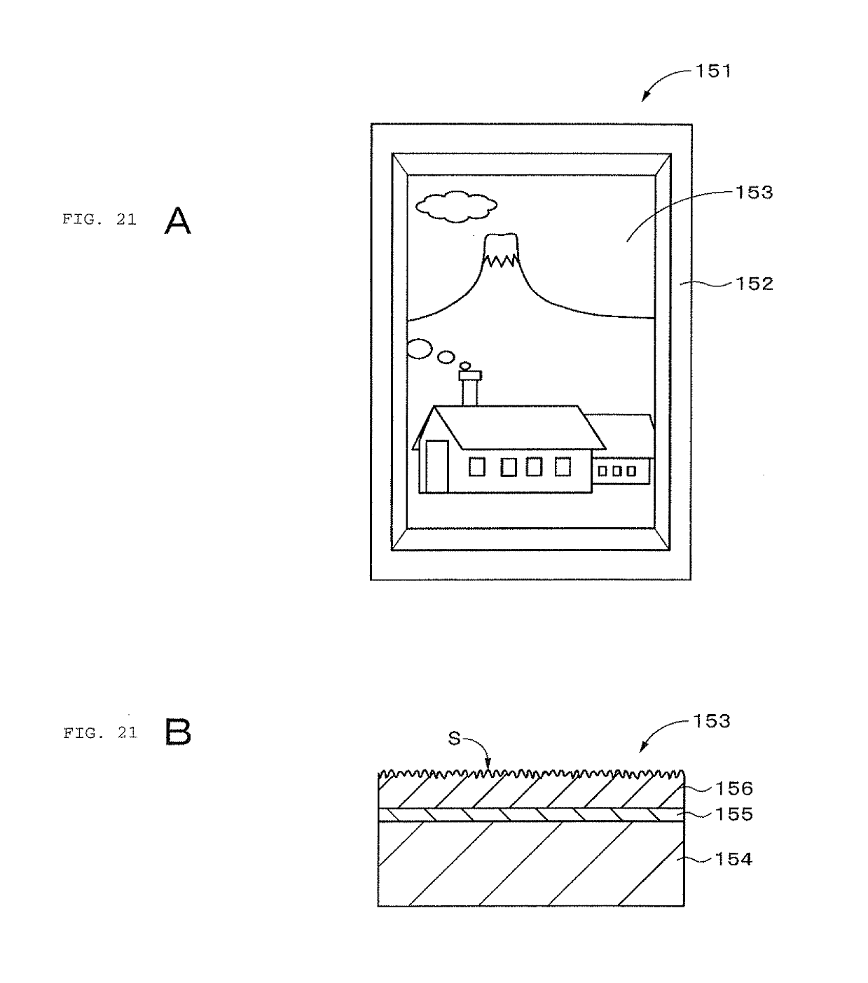

FIG. 21A is a plan view illustrating an exemplary configuration of a frame according to the eighth embodiment of the present technique. A frame 151 includes a frame part 152 and a cover member 153 fitted into the frame part 152 as shown in FIG. 21A.

FIG. 21B is a cross-sectional view illustrating an exemplary configuration of the cover member 153. The cover member 153 includes a cover member main body 154 and an optical body 156 provided on a surface thereof. A minute structure layer or an optical element, for example, is used as the optical body 156. The minute structure layer 12 according to the first embodiment, for example, may be used as such a minute structure layer. The optical element according to the first or second embodiment, for example, may be used as such an optical element. If an optical element is used as the optical body 156, it is possible to employ a configuration such that the optical element is adhered to the surface of the cover member main body 154 via an adhesive layer 155. If such a configuration is employed, a sheet having transparency and flexibility, or the like, is preferably used as the base member 11 of the optical element. Examples of the material for the cover member main body 154 may include, without being limited to, glass and an acrylic resin.

### [Advantageous Effects]

According to the eighth embodiment, since the cover member 153 of the frame 151 includes the optical body 156 having the minute concave-convex surface S, it is possible to suppress reflection at the surface of the cover member 153 of the frame. Thus, a visibility of a painting, photo, or the like set in the frame 151 can be improved.

### 9. Ninth Embodiment

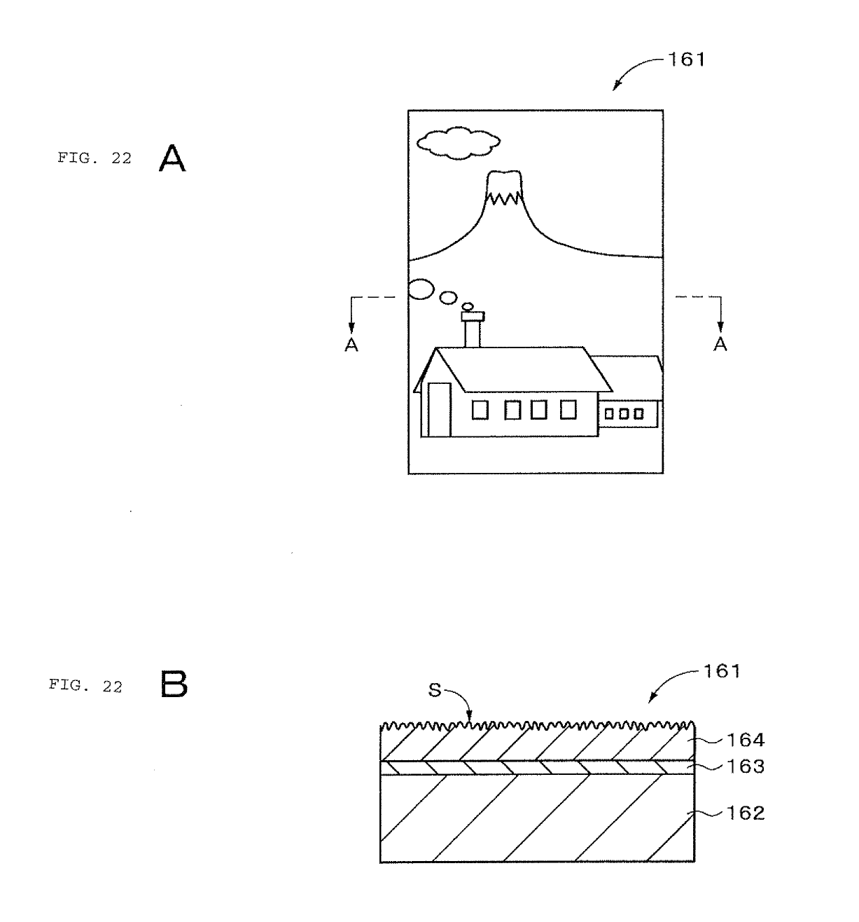

FIG. 22A is a plan view illustrating an exemplary configuration of a frame according to the ninth embodiment of the present technique. FIG. 22B is a cross-sectional view taken along the line A-A shown in FIG. 22A. As shown in FIG. 22B, a photo 161 includes a photo main body 162 and an optical body 164 provided on a surface of the photo main body 162. A minute structure layer or an optical element, for example, is used as the optical body 164. The minute structure layer 12 according to the first embodiment, for example, may be used as such a minute structure layer. The optical element according to the first or second embodiment, for example, may be used as such an optical element. If an optical element is used as the optical body 164, it is possible to employ a configuration such that the optical element is adhered to the surface of the photo main body 162 via an adhesive layer 163. If such a configuration is employed, a sheet having transparency and flexibility, or the like, is preferably used as the base member 11 of the optical element.

### [Advantageous Effects]

According to the ninth embodiment, since the photo 161 includes the optical body 164 having the minute concave-convex surface S, it is possible to suppress reflection at the surface of the photo 161. Thus, a visibility of the photo 161 can be improved.

### EXAMPLES

The present technique will now be specifically described below by way of examples. Note however that the present technique is not limited to these examples only.

In the present examples, the device shown in FIG. 3 was used as the laser processing device. IFRIT (trade name) manufactured by Cyber Laser Inc. was used as the laser main unit 40. The laser wavelength, repetition frequency, and pulse width thereof were set to 800 nm, 1000 Hz, and 220 fs, respectively.

### Example 1

The present technique will now be specifically described below by way of examples. Note however that the present technique is not limited to these examples only.

### Examples 1 to 7

First, DLC was coated on a surface of a base member to produce a master. Next, a femtosecond laser was applied on a surface of the DLC film of the master to form a minute concave-convex structure. At this time, the laser processing was conducted under the laser processing conditions shown in Table 1. Consequently, the plate-shaped master to be used for shape transfer was obtained. Note that the master had a square shape in a size of 2 cm×2 cm.

Next, the thus obtained master was used to form nanostructures on a surface of a ZEONOR film (manufactured by ZEON CORPORATION, registered trademark) by means of UV imprint. More specifically, the thus obtained master and the ZEONOR film on which an ultraviolet curable resin composition (hereinafter referred to as a “UV curable resin”) having a composition to be described below was coated were brought into close contact with each other, irradiated and cured with ultraviolet rays, and then peeled off. As a result, there was obtained a desired anti-reflection film.

### (Composition of UV Curable Resin)

A compound having a structure shown in the following formula (I): 95% by weight

A photopolymerization initiator (manufactured by BASF Ltd., trade name: Irgacure 184): 5% by weight

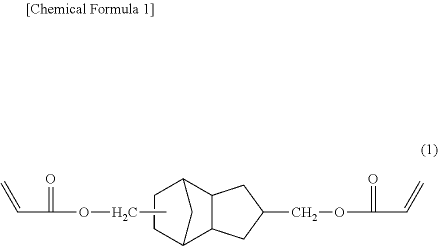

### Comparative Example 1

A UV curable resin was coated on a surface of a ZEONOR film and then cured without performing shape transfer. As a result, there was obtained an antifouling film having a flat surface. Note that the UV curable resin used was the same as that of Example 1 described above.

### Comparative Example 2

An anti-reflection film was obtained in the same manner as that of Example 1 except that laser processing was conducted under the laser processing conditions shown in Table 1 to produce a master to be used for shape transfer.

### Comparative Example 3

An anti-reflection film was obtained in the same manner as that of Comparative Example 2 except that SUS304 was coated on a surface of a base member instead of DLC.

### [Evaluations]

The thus obtained anti-reflection films of Examples 1 to 7 and Comparative Examples 1 to 3 were evaluated regarding (a) a concave-convex shape of a transferred surface (surface configuration, average pitch, and arithmetic average roughness), (b) a total light transmittance, (c) a haze, and (d) a Y value.

### (a) Concave-Convex Shape of Transferred Surface

### (Surface Configuration)

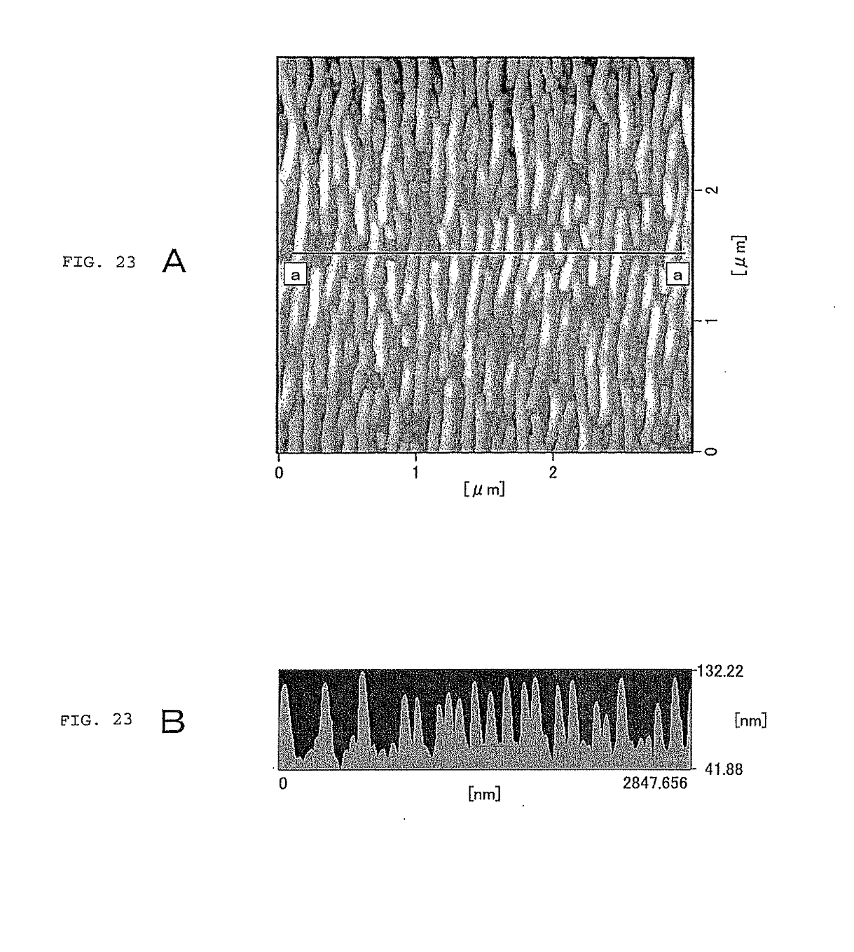

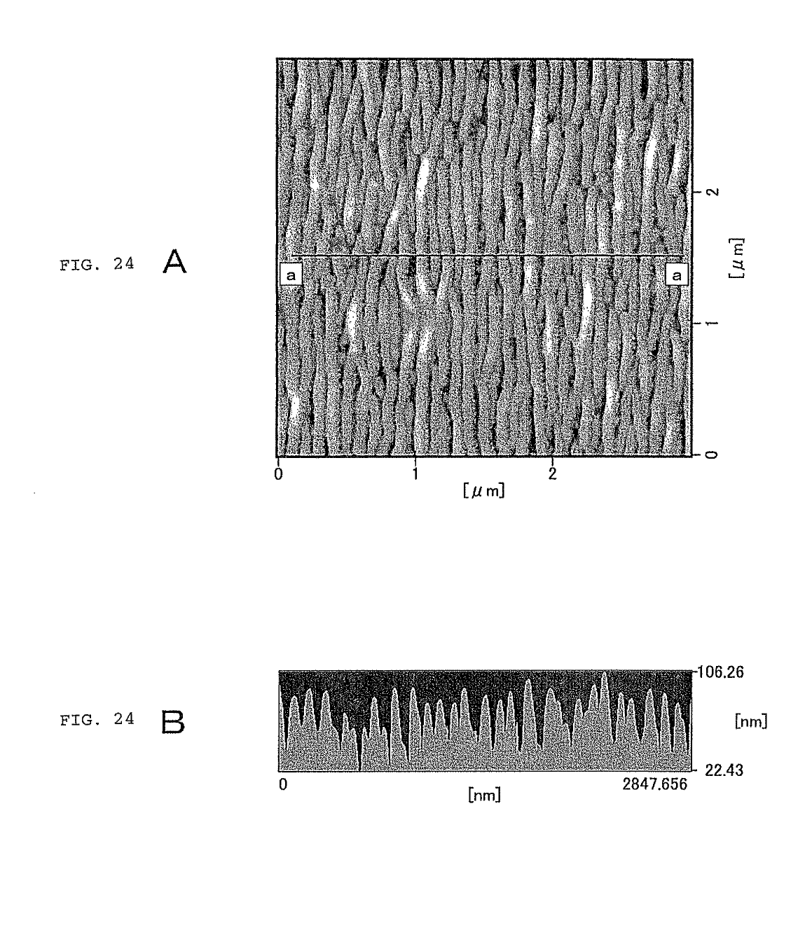

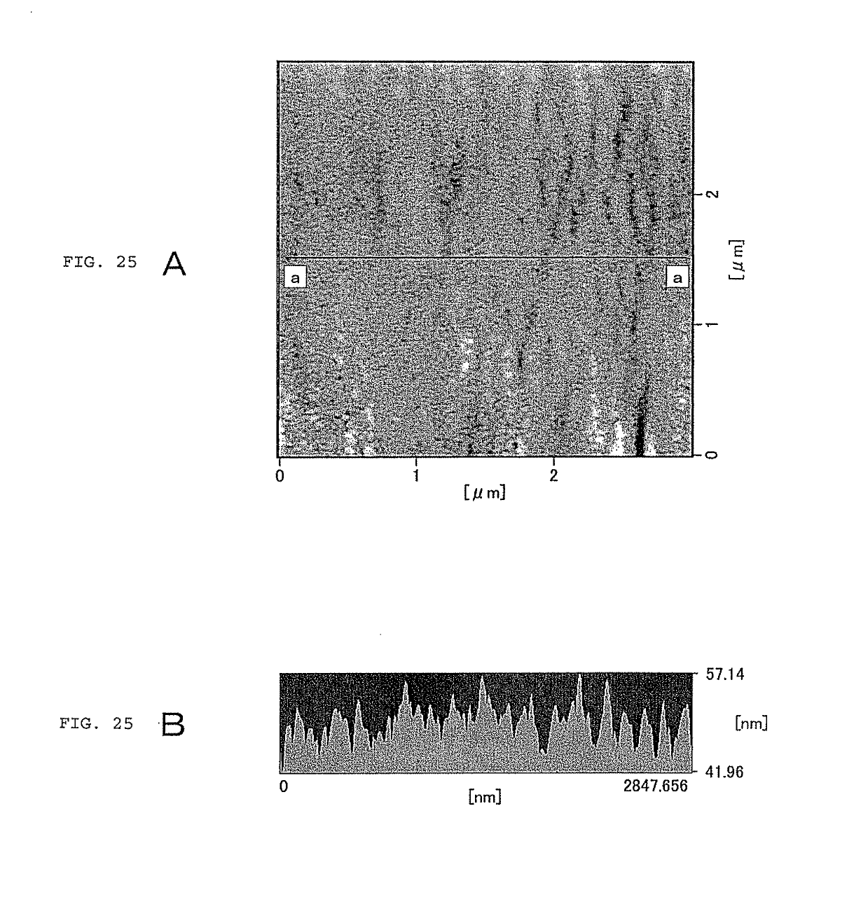

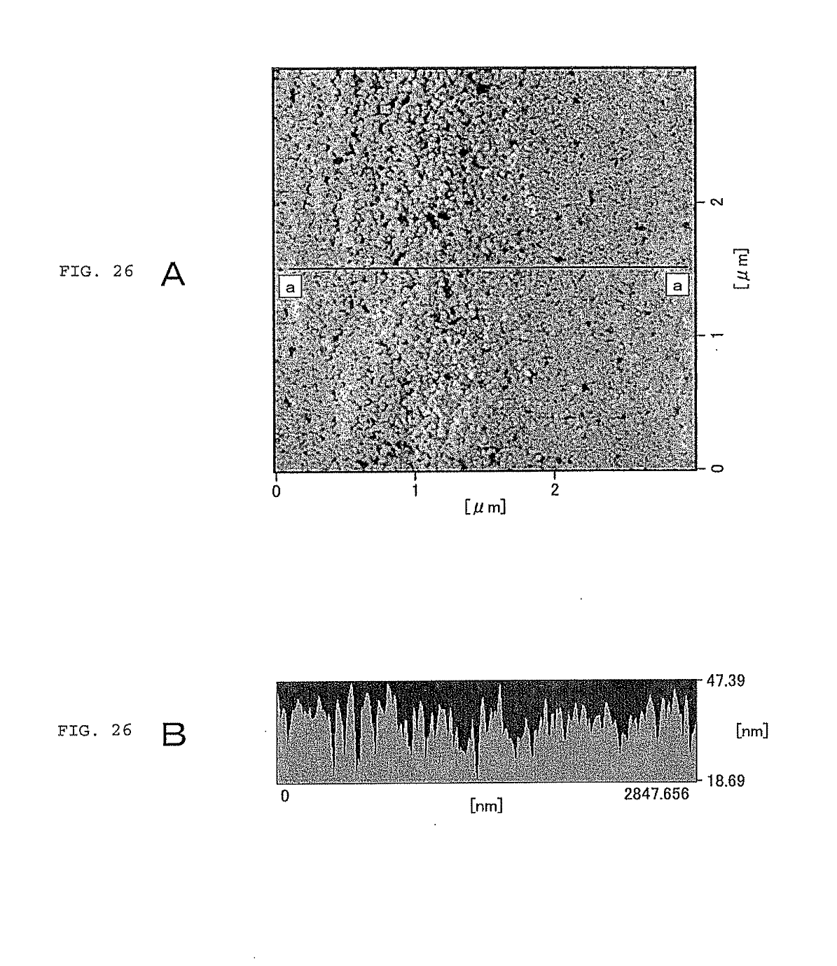

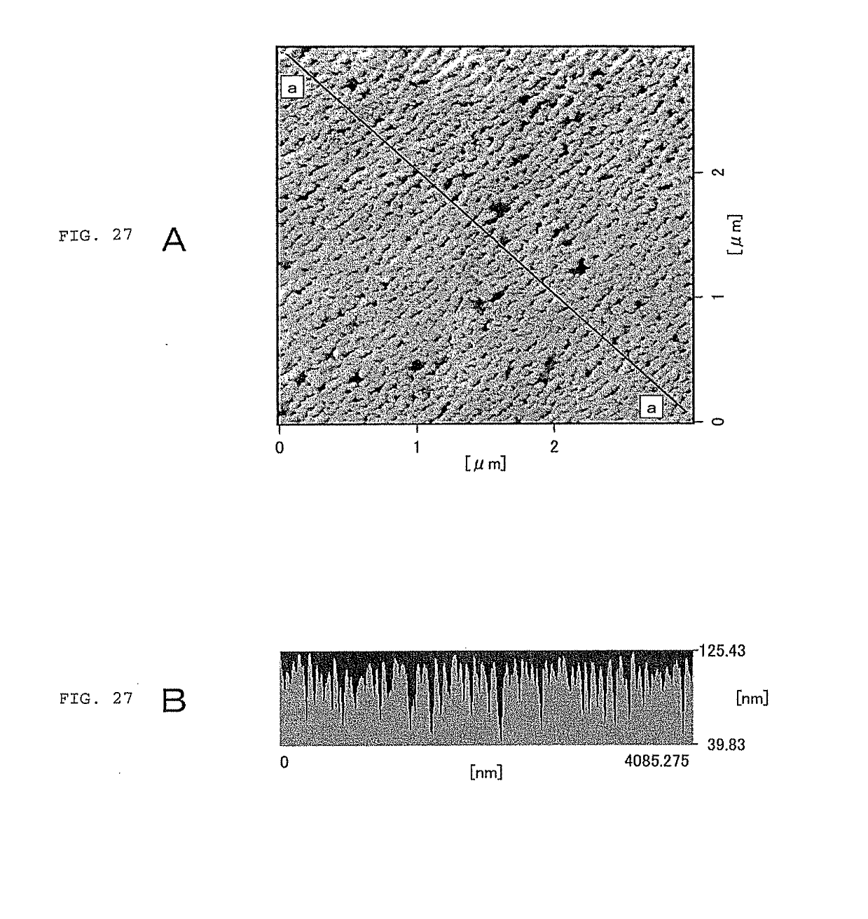

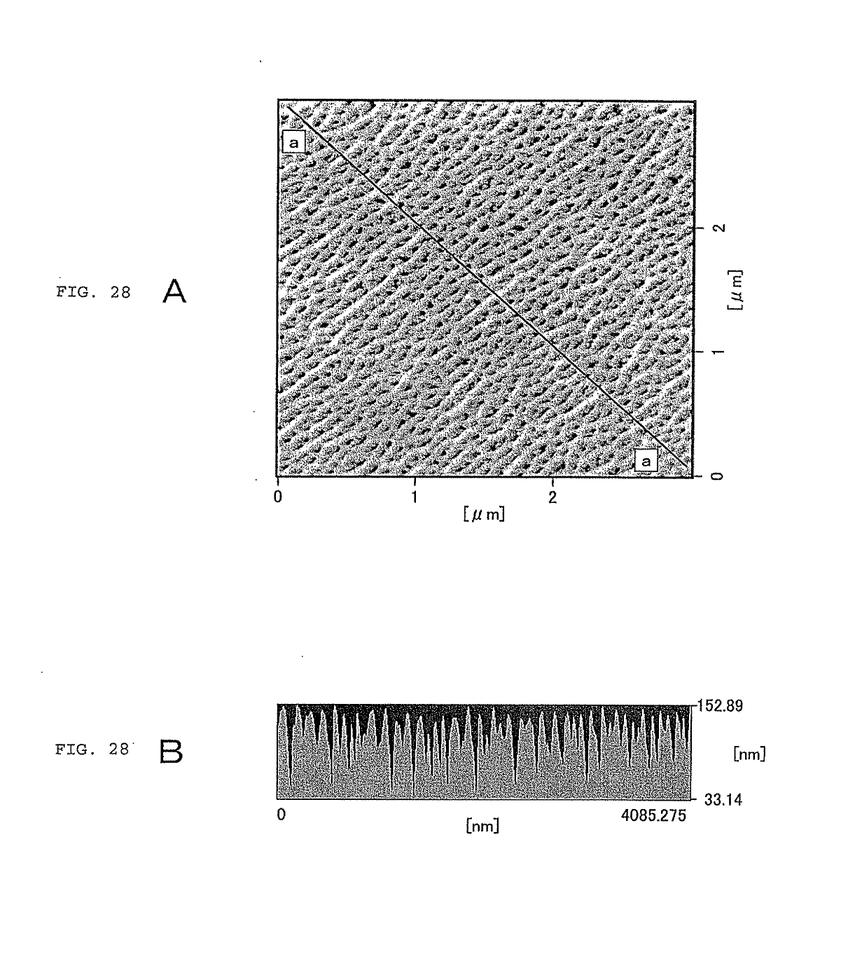

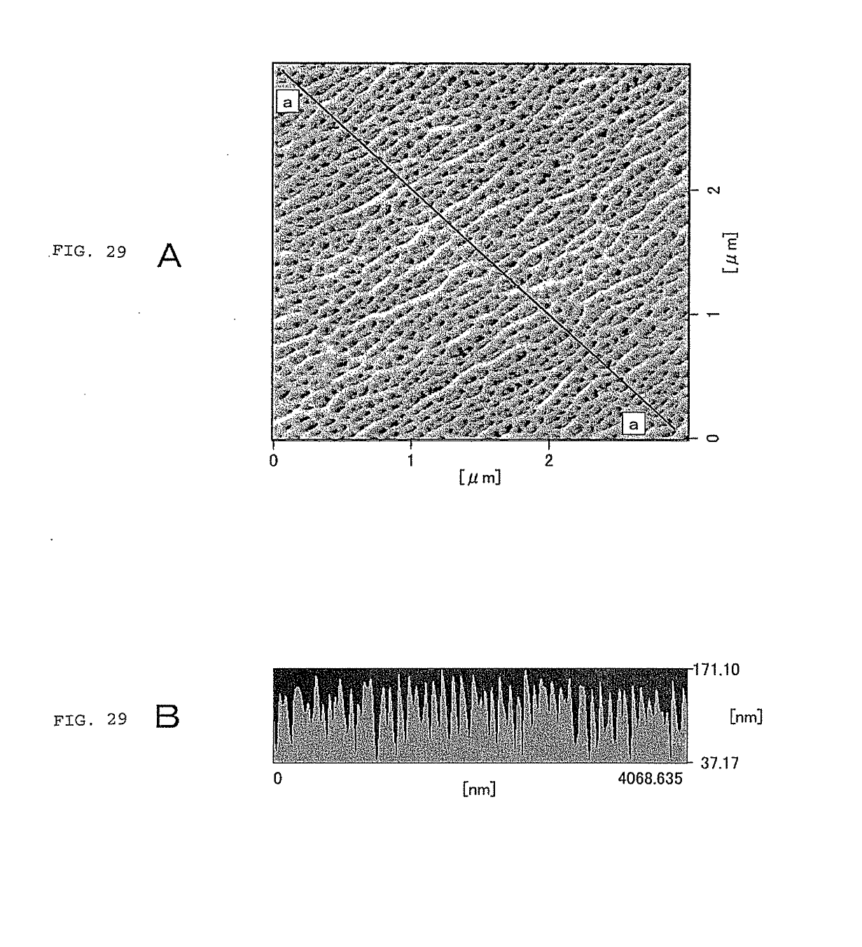

The film surfaces were observed with an atomic force microscope (AFM) in order to check the surface configurations thereof. FIGS. 23A, 24A, 25A, 26A, 27A, 28A, and 29A show AFM images on the surfaces of the anti-reflection films of Example 1, Example 2, Example 3, Example 4, Example 5, Example 6, and Example 7, respectively. FIGS. 23B, 24B, 25B, 26B, 27B, 28B, and 29B show cross-sectional profiles taken along the line a-a of FIGS. 23A, 24A, 25A, 26A, 27A, 28A, and 29A, respectively.

### (Average Pitch)

An average pitch Pm was obtained as will be described below from a cross-sectional profile of an AFM image. First, arbitrary two adjacent structures were chosen from the cross-sectional profile of the AFM image and a distance between these structures (shortest distance between tops of the minimum iteration structure) was obtained as a pitch. Next, this procedure was conducted at 10 arbitrary places on the minute concave-convex surface so as to obtain pitches P1, P2, . . . , P10. Next, these pitches P1, P2, P10 were simply averaged (arithmetic average) so as to obtain the average pitch Pm.

### (Arithmetic Average Roughness)

An arithmetic average roughness Ra was obtained as will be described below from an AFM image.

First, the minute concave-convex surface S in a field of view of 3 μm×3 μm was observed with the AFM. Next, the arithmetic average roughness ra was obtained from the cross-sectional profile of the AFM image. Thereafter, this procedure was conducted at 10 arbitrary places on the minute concave-convex surface so as to obtain ra1, ra2, . . . , ra10. Next, these values ra1, ra2, . . . , ra10 were simply averaged (arithmetic average) so as to obtain the arithmetic average roughness Ra.

### (b) Total Light Transmittance

Total light transmittances thereof were evaluated in accordance with JIS K7361 with HM-150 (trade name; manufactured by Murakami Color Research Laboratory Co., Ltd.).

### (c) Reflectance

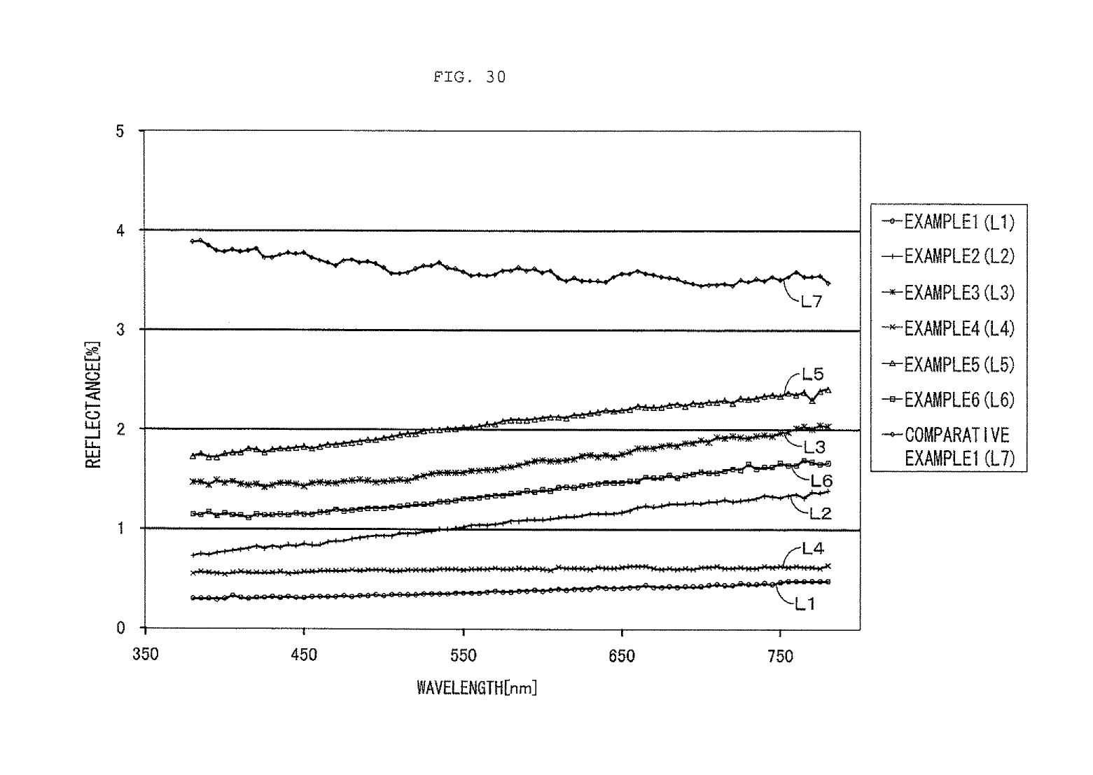

A black tape was adhered to a surface (rear surface) opposite to a minute concave-convex surface and the reflectance of the minute concave-convex surface at an incidence angle of 5° was evaluated using a spectrophotometer (manufactured by Hitachi High-Technologies Corporation, trade name: U-4100). FIG. 30 shows reflectance spectra of the anti-reflection films of Examples 1 to 6 and Comparative Example 1.

### (d) Haze

The total light transmittances thereof were evaluated in accordance with JIS K7361 with HM-150 (trade name; manufactured by Murakami Color Research Laboratory Co., Ltd.).

### (e) Y Value

A black tape was adhered to a surface (rear surface) opposite to a minute concave-convex surface and the reflectance of the minute concave-convex surface at an incidence angle of 5° was evaluated using the spectrophotometer (manufactured by Hitachi High-Technologies Corporation, trade name: U-4100). A Y value, a luminous reflectance, was calculated from the thus obtained reflectance spectrum.

Table 1 shows the materials and laser processing conditions of the anti-reflection film masters in Examples 1 to 7 and Comparative Examples 1 to 3.

TABLE 1

| | Material | Laser processing conditions | | | | | | | |
|---|---|---|---|---|---|---|---|---|---|
| | of | Wavelength | | | Lx (μm) | Ly (μm) | v | | F |
| | master | (nm) | Polarization | P (mW) | Horizontal | Vertical | (mm/s) | N | (J/cm²) |
| Example 1 | DLC | 800 | Linear | 96 | 300 | 160 | 8 | 20 | 0.2 |
| Example 2 | DLC | 800 | Linear | 96 | 300 | 160 | 5.33 | 30 | 0.2 |
| Example 3 | DLC | 800 | Linear | 96 | 300 | 160 | 10.66 | 15 | 0.2 |
| Example 4 | DLC | 800 | Linear | 96 | 300 | 160 | 16 | 10 | 0.2 |
| Example 5 | DLC | 800 | Circular | 96 | 300 | 160 | 8 | 20 | 0.2 |
| Example 6 | DLC | 800 | Circular | 96 | 300 | 160 | 5.33 | 30 | 0.2 |
| Example 7 | DLC | 800 | Circular | 96 | 300 | 160 | 3.2 | 50 | 0.2 |
| Comparative | — | — | — | — | — | — | — | — | — |
| Example 1 | | | | | | | | | |
| Comparative | DLC | 800 | Linear | 96 | 300 | 160 | 1.6 | 100 | 0.2 |
| Example 2 | | | | | | | | | |
| Comparative | SUS304 | 800 | Linear | 96 | 300 | 160 | 1.6 | 100 | 0.2 |
| Example 3 | | | | | | | | | |

DLC: Diamond-like carbon

Table 2 shows the evaluation results of the anti-reflection films of Examples 1 to 7 and Comparative Examples 1 to 3.

TABLE 2

| | Concave-convex shape | | | | | |
|---|---|---|---|---|---|---|
| | of transferred surface | | | Total light | | |
| | | Pm | Ra | transmittance | Haze | Y value |
| | Structure | (nm) | (nm) | (%) | (%) | (%) |
| Example 1 | Stripe- | 150 | 21 | 93.44 | 1.1 | 0.36 |
| | shaped | | | | | |
| Example 2 | Stripe- | 100 | 16 | 93.64 | 0.93 | 1.03 |
| | shaped | | | | | |
| Example 3 | Needle- | <50 | 3 | 93.5 | 0.74 | 1.59 |
| | shaped | | | | | |
| Example 4 | Needle- | <50 | 4.4 | 92.83 | 0.53 | 0.59 |
| | shaped | | | | | |
| Example 5 | Mesh- | 50 | 13 | 92.87 | 0.6 | 2.03 |
| | shaped | | | | | |
| Example 6 | Mesh- | 80 | 20 | 93.34 | 0.82 | 1.31 |
| | shaped | | | | | |
| Example 7 | Mesh- | 50 | 24 | 93.16 | 4.25 | 2.55 |
| | shaped | | | | | |
| Comparative | — | — | — | 91.63 | 0.49 | 3.59 |
| Example 1 | | | | | | |
| Comparative | Stripe- | 220 | 31 | 92.09 | 18.35 | 0.45 |
| Example 2 | shaped | | | | | |
| Comparative | Stripe- | 680 | 47 | 91.84 | 12.52 | 0.53 |
| Example 3 | shaped | | | | | |

Pm: average pitch
Ra: arithmetic average roughness

The followings were found out from the above-described evaluation results.

By forming a minute concave-convex surface with nanostructures having fluctuations in shape and setting the arithmetic average roughness Ra of the minute concave-convex surface to be 25 nm or less, the optical properties (anti-reflection property and transmission property) thereof can be improved while suppressing an increase in haze.

Although the embodiments and examples of the present technique have been described above in a specific manner, the present technique is not limited to the above-described embodiments and examples. Various modifications are possible on the basis of the technical idea of the present technique.

For example, the configurations, methods, processes, shapes, materials, numerical values, and the like given in the above-described embodiments and examples are illustrative only. Different configurations, methods, processes, shapes, materials, numerical values, and the like can be used if necessary.

Moreover, the configurations, methods, processes, shapes, materials, numerical values, and the like of the above-described embodiments and examples can be used in a combination thereof without departing from the scope of the present technique.

Also, the present technique can employ the following configurations.

(1)

An optical body having an anti-reflection function, comprising a minute concave-convex surface having fluctuations, wherein

the minute concave-convex surface has an arithmetic average roughness Ra of 25 nm or less.

(2)

The optical body according to (1), wherein

the minute concave-convex surface has an extended structure formed by convex portions extending one-dimensionally or two-dimensionally, and

the extended structure has fluctuations in shape.

(3)

The optical body according to (1), wherein the minute concave-convex surface includes a stripe-shaped, mesh-shaped, or needle-shaped structure.

(4)

The optical body according to any one of (1) to (3), wherein

the minute concave-convex surface is formed by structures having fluctuations in shape, and

the structures are arranged at an average pitch of smaller than or equal to 200 nm.

(5)

The optical body according to any one of (1) to (4), wherein a haze is smaller than or equal to 10%.

(6)

An input device comprising an input surface on which an optical body having an anti-reflection function is provided, wherein

the optical body is the optical body according to any one of (1) to (5).

(7)

A display device comprising a display surface on which an optical body having an anti-reflection function is provided, wherein

the optical body is the optical body according to any one of (1) to (5).

(8)

An electronic device comprising a surface on which an optical body having an anti-reflection function is provided; and

the optical body is the optical body according to any one of (1) to (5).

### REFERENCE SIGNS LIST

11, 21 . . . base member
12 . . . minute structure layer
12a, 22 . . . structure
12b . . . basal layer
13 . . . anchor layer
14 . . . hard coat layer
15 . . . transparent conductive layer
31 . . . plate-shaped master
32, 52 . . . structure
51 . . . roller master
101, 113, 125, 133, 143 . . . display device
102 . . . input device
103 . . . front panel
111 . . . TV device
112, 124, 132, 142 . . . housing
121 . . . laptop personal computer
131 . . . mobile phone
141 . . . tablet computer
151 . . . frame
161 . . . photo
S . . . minute concave-convex surface
S₁ . . . display surface
S₂ . . . input surface

1. An optical body having an anti-reflection function, comprising a minute concave-convex surface having fluctuations, wherein
the minute concave-convex surface has an arithmetic average roughness Ra of 25 nm or less.

2. The optical body according to claim 1, wherein
the minute concave-convex surface has an extended structure formed by convex portions extending one-dimensionally or two-dimensionally, and
the extended structure has fluctuations in shape.

3. The optical body according to claim 1, wherein the minute concave-convex surface includes any of a stripe-shaped structure, a mesh-shaped structure, and a needle-shaped structure.

4. The optical body according to claim 1, wherein
the minute concave-convex surface is formed by structures having fluctuations in shape, and
the structures are arranged at an average pitch of smaller than or equal to 200 nm.

5. The optical body according to claim 1, wherein a haze is smaller than or equal to 10%.

6. An input device comprising an input surface having an anti-reflection function, the input surface including a minute concave-convex surface having fluctuations, wherein
the minute concave-convex surface has an arithmetic average roughness Ra of 25 nm or less.

7. A display device comprising a display surface having an anti-reflection function, the display surface including a minute concave-convex surface having fluctuations, wherein
the minute concave-convex surface has an arithmetic average roughness Ra of 25 nm or less.

8. An electronic device comprising a surface having an anti-reflection function, the surface including a minute concave-convex surface having fluctuations, wherein
the minute concave-convex surface has an arithmetic average roughness Ra of 25 nm or less.
